(19) United States
(12) Patent Application Publication
(10) Pub. No.: US 2026/0104291 A1
(43) Pub. Date: Apr. 16, 2026

(54) OCCUPANCY DETERMINATION TECHNIQUES

(71) Applicant: View Operating Corporation, San Jose, CA (US)

(72) Inventors: Keivan EBRAHIMI, Fremont, CA (US); Aditya DAYAL, Sunnyvale, CA (US); Nitesh TRIKHA, Pleasanton, CA (US); Rao P. MULPURI, Saratoga, CA (US); Anurag GUPTA, San Jose, CA (US); Tanya MAKKER, Fremont, CA (US); Emily PUTH, Pleasanton, CA (US)

(73) Assignee: View Operating Corporation, San Jose, CA (US)

(21) Appl. No.: 19/256,763

(22) Filed: Jul. 1, 2025

Related U.S. Application Data
(63) Continuation of application No. PCT/US2023/084708, filed on Dec. 19, 2023.
(60) Provisional application No. 63/437,484, filed on Jan. 6, 2023.

(51) Int. Cl. G01J 5/00; G01J 5/10; G06V 10/147; G06V 20/52; G06V 40/10

(52) U.S. Cl. CPC G01J 5/0025; G01J 5/10; G06V 10/147; G06V 20/52; G06V 40/10; G01J 2005/0077; G01J 2005/106

(57) ABSTRACT

Techniques for determining occupancy data in a building include collecting IR imaging data with an infrared (IR) detector configured to collect IR imaging data, the IR detector having a field of view. The collected IR imaging data is processed by a controller determine occupancy data for a space, within a building, within the field of view of the IR detector. The controller includes circuitry configured to process the collected IR imaging data and determine occupancy data for a space, within a building, within the field of view of the IR detector, where the determined occupancy data excludes personally identifiable information (PII) of any occupant in the space.

### INCORPORATION BY REFERENCE

This application is a continuation of International Application No. PCT/US2023/084708 designating the U.S., filed on Dec. 19, 2023, which claims benefit of and priority to U.S. Provisional Application 63/437,484, titled “OCCUPANCY DETERMINATION TECHNIQUES,” and filed on Jan. 6, 2023; each of these applications is hereby incorporated by reference in its entirety and for all purposes.

### FIELD

The embodiments disclosed herein relate generally to techniques for sensing occupancy within a defined space such as a room of a building, and more particularly to use of an infrared sensing system to determine occupancy data that excludes personally identifiable information of the occupants.

### BACKGROUND

Occupants of a building, whether tenants or invitees, may have an expectation of privacy that is in tension with a building management's need to have an accurate understanding of occupancy density within the building as a function of time and location. Techniques for determining occupancy within a building will be disclosed that enable determining occupancy data with a desirable degree of temporal and spatial granularity while avoiding use of occupants' personally identifiable information (PII).

In some embodiments, the disclosed techniques are operable with networks of optically switchable windows, sometimes referred to as “smart windows”. A network of smart windows, i.e., a “window network” may include a window controller network (WCN) and be communicatively coupled with a building management system (BMS).

### BRIEF DESCRIPTION OF THE DRAWINGS

FIGS. 1A through 1C show various link technologies and topologies that may be used with the present disclosure.

FIG. 2 shows an example of a control system architecture comprising a master controller that controls intermediate controllers, that in turn control local controllers.

FIG. 3 illustrates a block diagram showing an example of components that may be present in certain implementations of a digital architectural element (DAE).

FIGS. 4A through 4C illustrate a number of examples of applications and uses of the digital architectural element and related elements contemplated by the present disclosure.

FIG. 5 illustrates examples of functionalities of the digital architectural element not directly related to controlling windows.

FIG. 6 illustrates a process flow for measuring a plurality of building conditions, and controlling building operation parameters of a plurality of building systems responsive to the measured building conditions, according to some embodiments

FIG. 7 illustrates an example of a suite of functional modules, configured to execute the process flow illustrated in FIG. 6 according to an implementation.

FIGS. 8A through 8C illustrate block diagrams of systems for determining occupancy data, according to various embodiments.

FIG. 9 shows an example low resolution IR image of an occupied space.

FIGS. 10A through 10D illustrate embodiments of an occupancy determination system in accordance with various embodiments.

FIG. 11 shows a plurality of occupancy determination systems distributed through a building.

FIG. 12 illustrates a plurality of occupancy determination systems coupled to a remote processor.

FIGS. 13A and 13B illustrate a process flow diagram for determining occupancy data, according to an embodiment.

FIG. 14 illustrates a DAE that can support multiple communication types, according to some embodiments.

FIG. 15 illustrates a system of components that may be incorporated in or associated with a DAE, according to some embodiments.

FIG. 16 illustrates an example of a system of components that may be incorporated in or associated with a digital architectural element, according to some embodiments.

FIG. 17 illustrates a block diagram of a computer implemented system operable to determine occupancy data according to an embodiment.

### DETAILED DESCRIPTION

The following detailed description is directed to certain embodiments or implementations for the purposes of describing the disclosed aspects. However, the teachings herein can be applied and implemented in a multitude of different ways. In the following detailed description, references are made to the accompanying drawings. Although the disclosed implementations are described in sufficient detail to enable one skilled in the art to practice the implementations, it is to be understood that these examples are not limiting; other implementations may be used and changes may be made to the disclosed implementations without departing from their spirit and scope. Furthermore, while the disclosed embodiments focus on electrochromic windows (also referred to as optically switchable windows, tintable and smart windows), the concepts disclosed herein may apply to other types of switchable optical devices including, for example, liquid crystal devices and suspended particle devices, among others. For example, a liquid crystal device or a suspended particle device, rather than an electrochromic device, could be incorporated into some or all of the disclosed implementations. Additionally, the conjunction “or” is intended herein in the inclusive sense where appropriate unless otherwise indicated; for example, the phrase “A, B or C” is intended to include the possibilities of “A,” “B,” “C,” “A and B,” “B and C,” “A and C,” and “A, B, and C.”

Occupants of a building, whether tenants or invitees, may have an expectation of privacy that is in tension with a building management's need to have an accurate understanding of occupancy density within the building as a function of time and location. Techniques for determining occupancy within a building will be disclosed that enable determining occupancy data with a desirable degree of temporal and spatial granularity while, in some embodiments, avoiding use of occupants' personally identifiable information (PII). “PII”, as used herein, refers to information that can be used to distinguish or trace an individual's identity. In the presently disclosed techniques, “avoiding use of” or “excluding” PII means, depending on context, avoiding the collection of PII altogether, or, to the extent PII is collected (e.g. by a sensor) and processed (e.g. by a sensor controller) preventing dissemination of the PII from the sensor controller.

In some embodiments, the disclosed techniques are operable with networks of optically switchable windows, sometimes referred to as “smart windows”. Such windows exhibit a controllable and reversible change in an optical property when appropriately stimulated by, for example, a voltage change. The optical property is typically color, transmittance, absorbance, and/or reflectance. Electrochromic (EC) devices are sometimes used in optically switchable windows. Such windows may be used in buildings to control transmission of solar energy, may be manually or automatically tinted and cleared to reduce energy consumption, by heating, air conditioning and/or lighting systems, while maintaining occupant comfort. A network of smart windows, i.e., a “window network” may, advantageously, be communicatively coupled with the occupancy determination system of the present disclosure. In some embodiments, the occupancy determination system may be communicatively coupled with one or both of a window controller network (WCN) and a building management system (BMS).

Using the disclosed techniques, building managers, the BMS and/or the WCN are enabled to anticipate current and future occupant needs through accurate and anonymous occupant-counting technology. Near real-time, substantially continuous knowledge of occupancy density enables similarly real-time and continuous operating adjustments to HVAC and lighting systems, for example, to enhance occupant comfort while not violating occupants' privacy expectations. Building security may be enhanced by the capability to promptly detect persons present in a space or at a time when their presence may be unauthorized. Building owners and/or tenants may obtain a deeper understanding of how physical spaces in a building are used as a function of time and be enabled to make proactive space planning decisions.

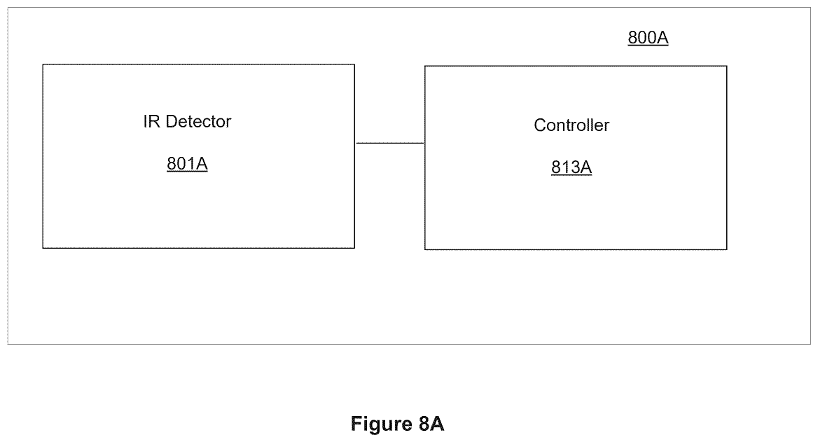

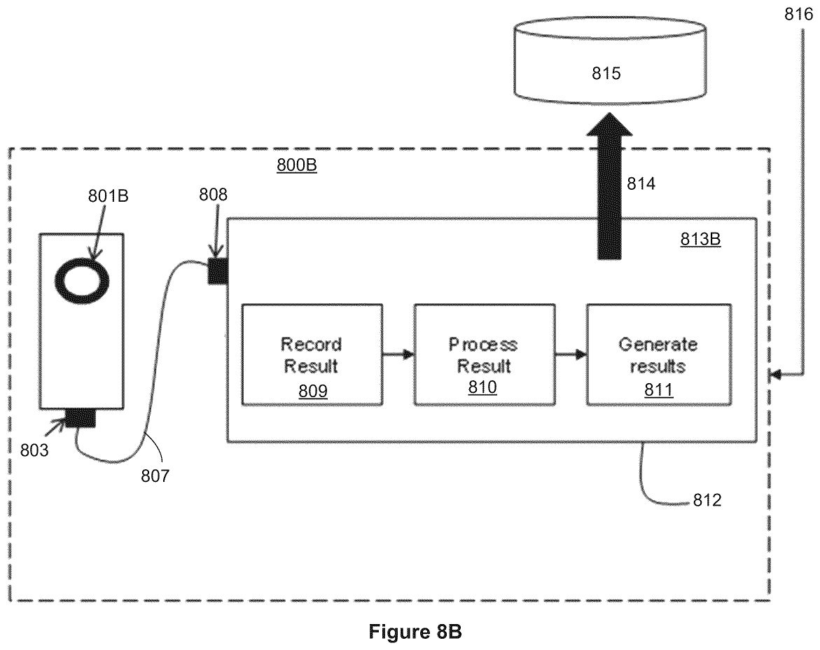

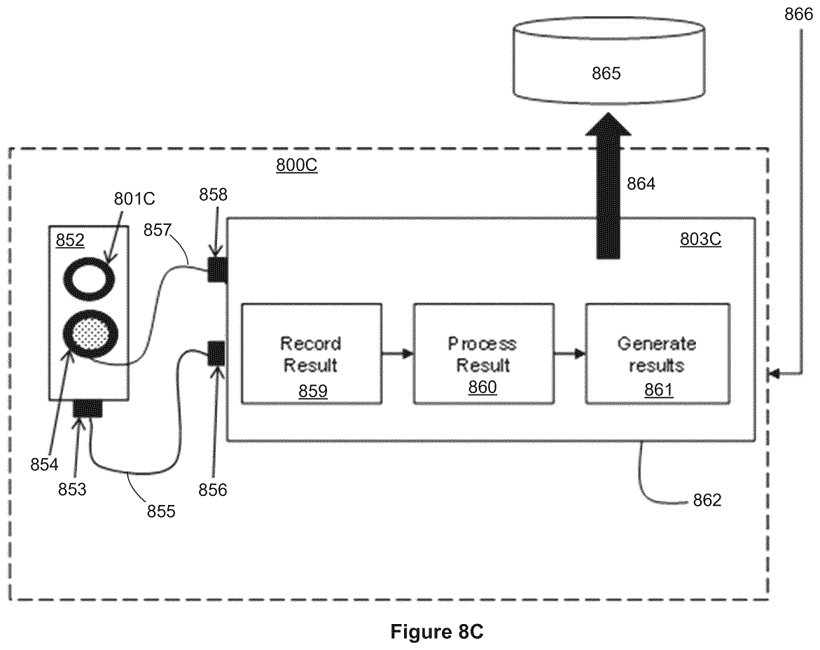

FIG. 8A shows a simplified block diagram of a system for determining occupancy data that excludes personally identifiable information (PII), according to an embodiment. In the illustrated embodiment, system 800A includes an infrared (IR) detector 801A configured to collect IR imaging data within the detector's field of view. The IR detector 801A in some embodiments may be a far infrared thermal array such as models available from Melexis NV of leper, Belgium). The system 800A also includes a controller 813A. The controller 813A includes circuitry configured to process the IR imaging data collected by the IR detector 801A and to determine occupancy data for a space, within a building, within the field of view of the IR detector 801A. Advantageously, in this embodiment, the determined occupancy data excludes PII of any occupant in the space. In some embodiments, exclusion of PII may be obtained by selection of an appropriately low resolution for the IR detector 801A. For example, the IR detector 801A may be configured to collect IR imaging data at a resolution no greater than 100×100 pixels per 1000 square feet of a viewable area within the field of view. Accordingly, in some such embodiments, the collected IR imaging data does not collect any PII due to the relatively low resolution. In some embodiments, the resolution may be about 32×24 pixels per 1000 square feet of the viewable area. Alternatively or in addition, exclusion of PII may be obtained by a processing step executed by controller 813A in which PII collected by the IR detector 801A is scrubbed or masked before being transmitted outside the system 800A. In some implementations, the controller 813A is a single board computer (SBC).

In some embodiments the IR detector 801A is an IR thermal sensor array. For example, the IR sensor array may consist of 768 IR sensors disposed in a 32×24 array. In some embodiments the field of view of the IR detector 801A is about 110° in a first direction and about 75° in a second direction orthogonal to the first direction.

FIG. 8B shows a further example of a system for determining occupancy data that excludes PII. The system 800B includes an IR detector 801B and a controller 813B. In the illustrated embodiment, the thermal detector 801B is coupled to the controller 813B via cabling 807 and connectors 803 and 808 (e.g., a USB connector, or any other connector, e.g., as disclosed herein). The IR detector 801B has an associated field of view, and the controller 813B may be configured to process the collected IR imaging data and determine occupancy data for a space, within a building, within the associated field of view. Processing the collected IR imaging data may include the controller 813B recording IR imaging data collected by the IR detector 801B as indicated by block 809. The recorded data may be processed as indicated by block 810, and results (e.g., occupancy data or other insights) may be generated as indicated by block 811. The results, advantageously, exclude personally identifiable information (PII) of any occupant in the space. In the illustrated embodiment, the controller 813B is connected to power source 812 and is operatively coupled via link 814 (e.g., wired and/or wireless connection such as WiFi connection) to a storage (e.g., database) 815. In the illustrated embodiment, the system 800B and the database 815 are operatively coupled to a network 816, that controls, for example a building or other facility in which the system 800B is disposed. The database 815 may disposed in or may be remote from the facility.

FIG. 8C shows a yet further example of a system for determining occupancy data that excludes PII. The system 800C includes two sensors including an IR detector 801C, and an optical camera 854. In the illustrated embodiment, the IR detector 801C and the optical camera 854 are disposed in a common housing, 852. For example, the IR detector 801C and the optical camera 854 may be housed in a device ensemble such as a digital architectural element (DAE) as described hereinbelow. The IR detector 801C and the optical camera 854 may be coupled to at least one processor 803C via cabling. The optical camera may utilize a separate cabling from that of the thermal camera. For example, cabling 857 may couple the optical camera to the at least one processor 803C via connector 858, and the thermal detector 801C may be coupled via cabling 855 to the at least one processor 803C via connectors 853 and 856. The connectors may be USB connectors, or any other connector (e.g., as disclosed herein). The at least one processor 803C may be configured to record the results accumulated by the IR detector 801C and the optical camera 854 as indicated by block 859. The recorded data may be processed as indicated by block 860, and results (e.g., insights) may be generated as indicated by block 861. In the illustrated embodiment, the at least one processor 803C is connected to power source 862 and is operatively coupled via link 864 (e.g., wired and/or wireless connection such as WiFi connection) to a storage (e.g., database) 865. In the illustrated embodiment, the system 800C and the database 865 are operatively coupled to a network 866, that controls, for example a building or other facility in which the system 800C is disposed. The database 865 may disposed in or may be remote from the facility.

In some embodiments, the IR detector (801A, 801B and 801C) detector is configured to collect IR imaging data at a resolution no greater than 100×100 pixels per 1000 square feet of a viewable area within the field of view. In some embodiments, the resolution is about 32×24 pixels per about 500 to 1000 square feet of viewable area. In some embodiments the viewable area is a planar, or substantially planar, area disposed between a floor and a ceiling of the space. The planar area may be approximately four feet above the floor, in some embodiments. The viewable area may be about 500 to about 1000 square feet. In some embodiments, the viewable area is about 10 feet×20 feet.

Processing the results (at blocks 810 and/or 860) may comprise cleaning noise from and/or calibrating the captured sensor measurements. The noise may arise from the background environment of the space in which occupancy is being detected. Results generated (at blocks 811 and/or 861) may constitute the determined occupancy data, excluding PII and may be saved in the database as, for example, a log file.

In some embodiments, the power required by processors 803B and 803C (from power sources 812 and 862, respectively) may comprise at most 2V, 4V, 5V, or 10 Volts (V) and at most 1 A, 2A, or 3 amperes (A). The at least one processor (803B or 803C) may comprise a CPU or a GPU. The at least one processor may comprise a media player. The at least one processor may be included in a circuit board. The circuit board may comprise a Jetson Nano™ Developer Kit by NVIDIA®, (e.g., 2 GB or 4 GB developer kit) or Raspberry-Pi kit (e.g., 1 GB, 2 GB, 4 GB, or 8 GB developer kit). The at least one processor may be operatively coupled to a plurality of ports comprising at least one media port (e.g., a DisplayPort, HDMI, and/or micro-HDMI), USB, or an audio-video jack, e.g., that may be included in the circuit board. The at least one processor may be operatively coupled to a Camera Serial Interface (CSI), or a Display Serial Interface (DSI), e.g., as part of the circuit board. The at least one processor is configured to support communication such as ethernet (e.g., Gigabit Ethernet). The circuitry board may comprise a Wi-Fi functionality, a Bluetooth functionality, or a wireless adapter. The wireless adapter may be configured to comply with a wireless networking standard in the 802.11 set of protocols (e.g., USB 802.11ac). The wireless adapter may be configured to provide a high-throughput wireless local area networks (WLANs), e.g., on at least about a 5 GHz band. The USB port may have a transfer speed of at least about 480 megabits per second (Mbps), 4,800 Mbps, or 10,000 Mbps. The at least one processor may comprise a synchronous (e.g., clocked) processor. The clock speed of the processor may be of at least about 1.2 Gigahertz (GHz), 1.3 GHZ, 1.4 GHz, 1.5 GHZ, or 1.6 GHz. The at least one processor may comprise a random access memory (RAM). The RAM may comprise a double data rate synchronous dynamic RAM (SDRAM). The RAM may be configured for mobile devices (e.g., laptop, pad, or mobile phone such as cellular phone). The RAM may comprise a Low-Power Double Data Rate (LPDDR) RAM. The RAM may be configured to permit a channel that is at least about 16, 32, or 64 bits wide.

The at least one processor may comprise a single circuit board computer (SBC). The at least one processor may be configured to run a plurality of neural networks in parallel (e.g., for image classification, object detection, segmentation, and/or speech processing). The at least one processor may be powered by at most about 10 watts (W), 8 W, 5 W, or 4 W.

Any of the systems 800A, 800B and 800C may be included in or configured as a digital architectural element (DAE). A DAE, as the term is used herein, and in the claims, refers to an arrangement of one or more sensors and associated electronics packaged or enclosed in a manner to facilitate integration with or mounting on an architectural feature of a building, such as a wall, ceiling, floor, window, window frame, window mullion or the like.

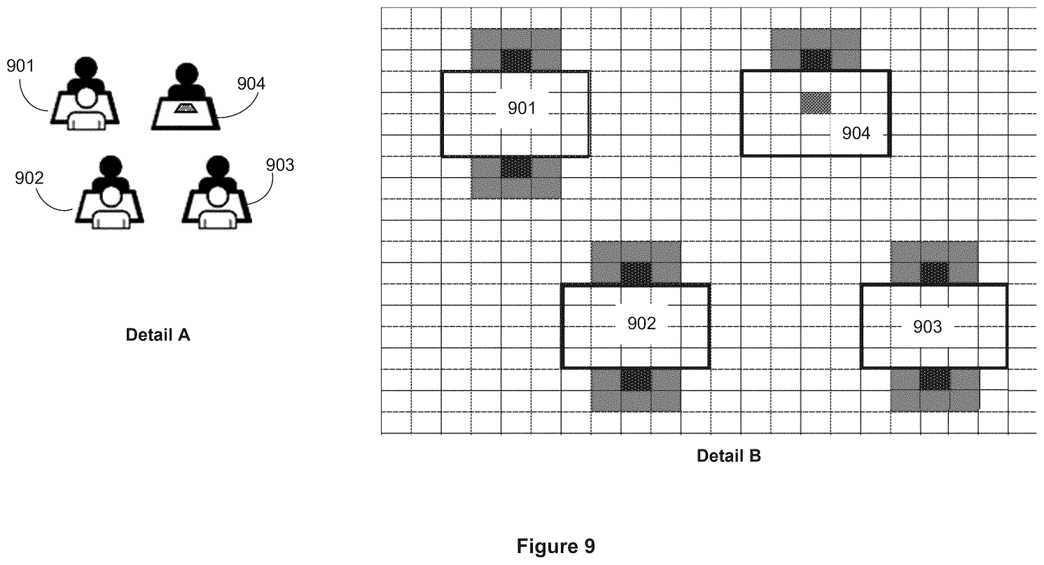

FIG. 9 shows an example low resolution IR image of an occupied space. Referring first to Detail A, a stylized perspective view of seven individuals seated at four tables is presented. Respective pairs of individuals are shown as occupying tables 901, 902 and 903, whereas table 904 is shown as being occupied by a single individual facing an operating personal electronic device. Detail B illustrates how features illustrated Detail B may appear when imaged by ceiling mounted, downward looking, low resolution IR detector. Output of the IR detector is sufficient to distinguish the presence of discrete individuals (as well as other sources of thermal gradients such as pets or service animals, electronic devices, HVAC registers, operating equipment, etc.), but insufficient to distinguish any PII of the individual occupants.

It will be appreciated that Detail B may represent one frame of IR imaging data and that successive frames may be obtained by the IR detector at various frame rates (e.g., 1-60 times per minute). As a result, a controller processing the successive frames of imaging data may be readily capable of distinguishing animate from inanimate sources of thermal gradients.

The controller may, additionally, apply other techniques to more accurately determine occupancy data including a count of the number of individuals within the IR detector's field of view and occupant density within the viewable area of the IR detector. For example, a thermal background signature for the unoccupied space may be obtained by periodically capturing IR data when no occupants are present. Subsequently, the thermal background signature may be subtracted from collected IR imaging data to construct a difference image. The controller may also utilize blob detection techniques on the difference image to detect occupants. In some embodiments, the blob detection techniques include “you only look once” (YOLO) techniques.

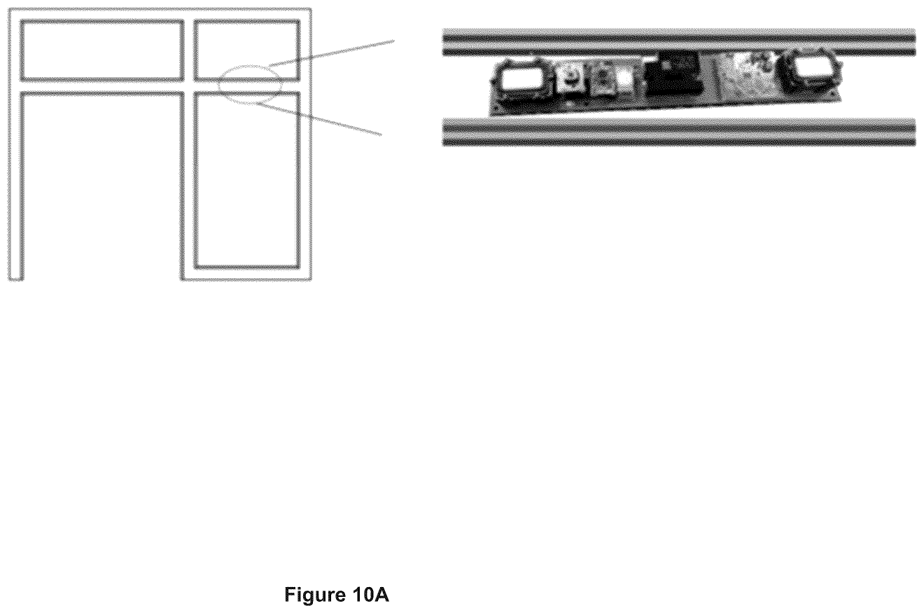

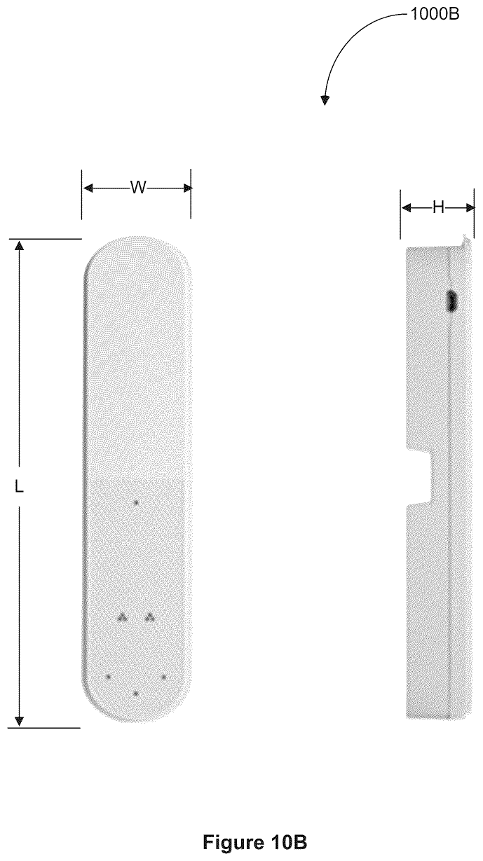

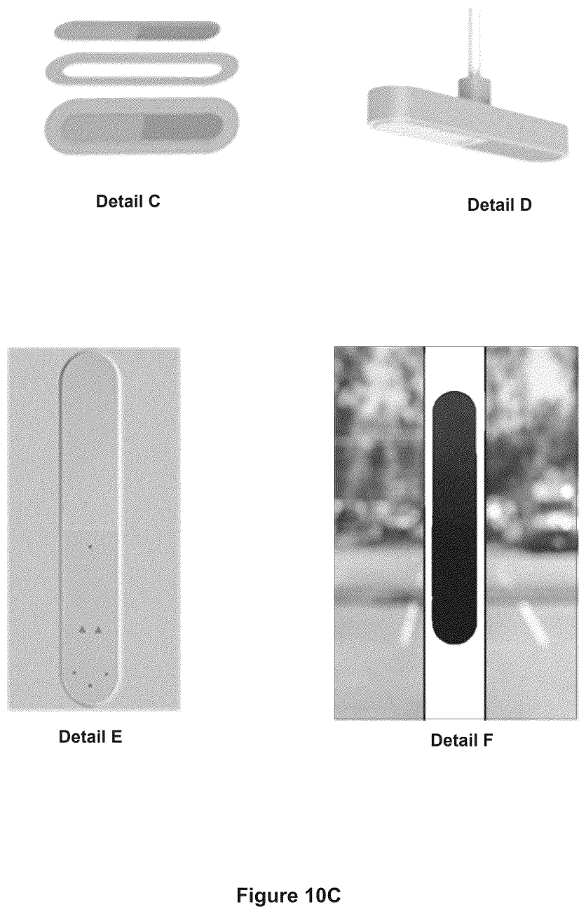

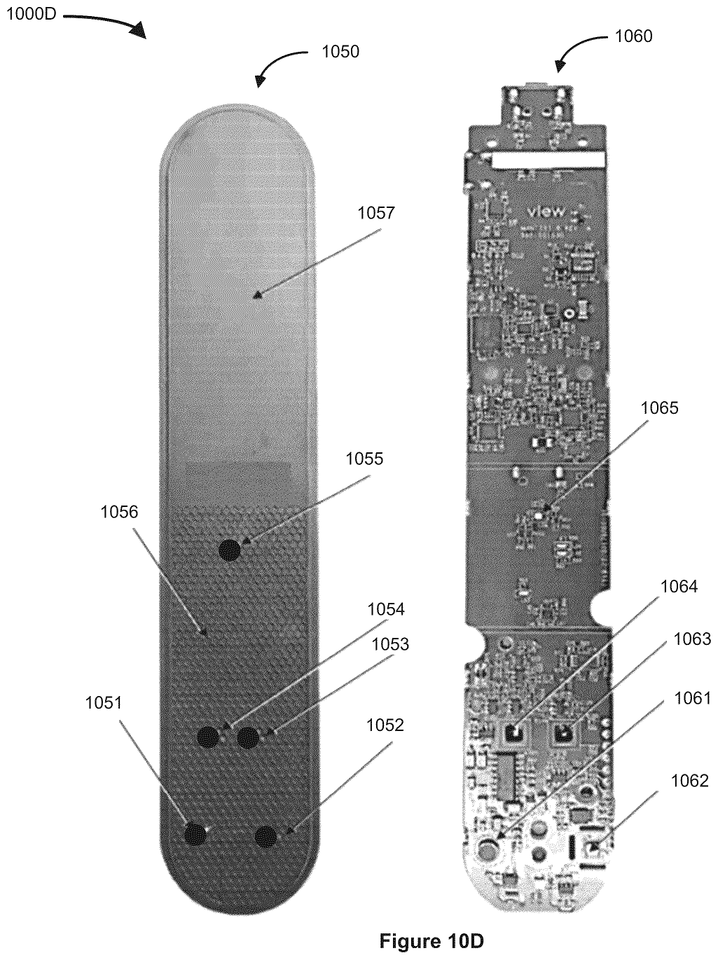

As indicated above, in some embodiments, the occupancy data determination system contemplated by this disclosure may be configured as a DAE. FIG. 10A illustrates an example physical packaging of a DAE, according to some implementations. As may be observed in FIG. 10A, it is contemplated that the functionality of the described sensors controllers and associated circuitry may be configured in a physical package having a size and form factor that can be readily accommodated by an architectural feature such as a typical window mullion.

Referring now to FIG. 10B, an exterior view of a further example of a DAE is provided. In the illustrated implementation DAE 1000B has a characteristic length, ‘L’, width, ‘W’, and height, ‘H’. Advantageously, L may be less than 12 inches while each of W and H are less than 3 inches. In some implementations, L is about 8 inches, W is about 2 inches and His about 1 inch.

As illustrated in FIG. 10C, a DAE may be installed on or proximate to a ceiling, either flush mounted (Detail C) or pendant mounted (Detail D) such that it is positioned offset from, e.g., below, a ceiling surface. In other implementations, a DAE may be wall mounted (Detail E), or disposed on a window frame (Detail F)

Referring now to FIG. 10D a further example of a DAE is illustrated. In addition to the IR detector and controller contemplated in the embodiments described herein above, the DAE 1000D may have components providing other functionalities as will now be described, for example. The DAE 1000D includes an enclosure cover 1050. In the illustrated embodiment, a first portion 1057 of an external surface of cover 1050 has a relatively smooth surface finish, whereas a second portion 1056 has a patterned, relatively rough surface finish. In the illustrated embodiment, the second portion 1056 has a hexagonal (honeycomb) pattern). The second portion 1056 may be configured with a plurality of holes including 1051, 1052, 1053, 1054, and 1055. The enclosure cover 1050 may be disposed so as to house (and shroud from view) a circuit board (e.g., printed circuit board) 1060 that includes devices. The devices can the IR detector and controller disclosed hereinabove (not illustrated) as well as comprise other sensor(s), emitter(s), processor(s), network interface, memory, transceiver, antenna(s), communication and power port(s), and/or any other device disclosed herein. The holes 1051-1052 may be disposed such that they align with a sensor or sensor array. The sensor(s) may be disposed on a front side of circuit board 1060 facing a viewer or occupant of a room, or on a back side of the circuit board 1060 facing away from the viewer/occupant. For example, hole 1051 may align with a sound sensor 1061 disposed on the front side of circuit board 1060 facing the viewer; hole 1052 may align with a sensor 1062 disposed on the front side of circuit board 1060 facing the viewer; hole 1053 may align with a sensor 1063 disposed on a back side of circuit board 1060 away from the viewer; hole 1054 may align with a sensor 1064 disposed on a back side of circuit board 1060 away from the viewer; hole 1055 may align with a sensor 1065 disposed on the front side of circuit board 1060 facing the viewer. The sensor(s) disposed in the back side of circuit board 1060 may be gas sensor(s) such as carbon dioxide and/or humidity sensors. The circuit board may have a plurality of temperature sensors configure to sense temperature of the DAE interior and/or exterior. A sensor that may be configured to sense the DAE may be aligned with a hole in the device ensemble casing cover 1050. Examples of sensor and/or emitter configuration in a device ensemble are disclosed in International Patent Application Serial No. PCT/US21/30798 filed May 5, 2021, titled “DEVICE ENSEMBLES AND COEXISTENCE MANAGEMENT OF DEVICES,” which is incorporated herein by reference in its entirety.

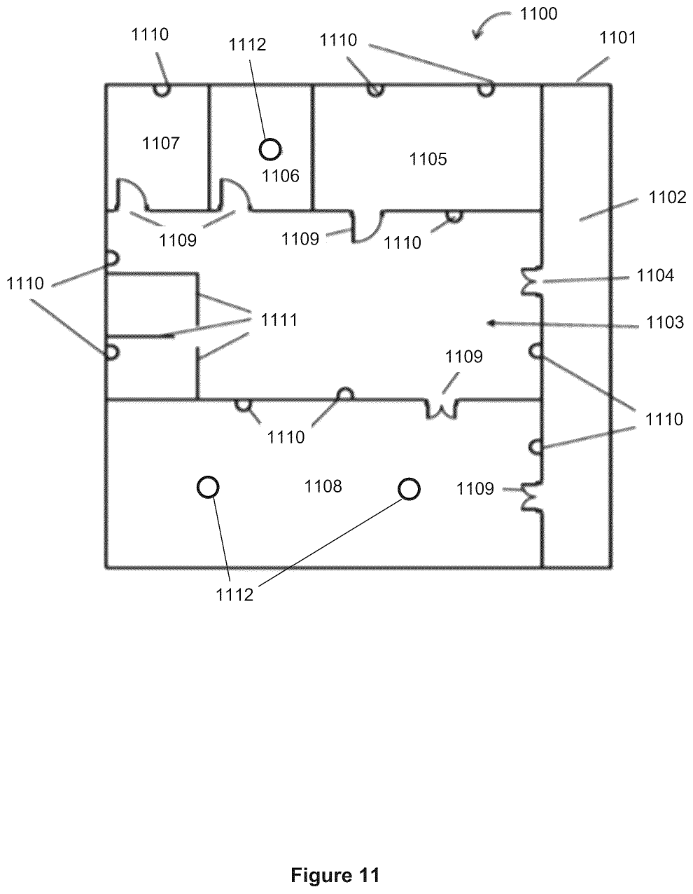

In some implementations, a building including one or more occupancy sensing systems distributed within the building may be contemplated. Referring now to FIG. 11, an example representation 1100 of an occupiable space 1101 is presented. Space 1101 may be, for example, a floor of a multi-story building. In the illustrated example, an outer hallway 1102 has access to an office suite 1103 via a main door 1104. The office suite includes inner offices 1105, 1106, and 1107 and a conference room 1108. Doors 1109 provide access to inner offices 1105-1107 and conference room 1108 as shown. Finally, a center area of suite 1103 includes partitions 1111 for cubicles. In some embodiments, a plurality of DAEs may be installed throughout all or any part of office suite 1103. In the illustrated example some DAEs 1110 may be mounted to a wall or to a frame or mullion of a window; other DAEs 1112 are ceiling mounted. In some spaces, e.g., offices 1106, 1107, cubicles 1111, a single respective DAE may be assigned to the space. In larger spaces, e.g. suite 1103 conference room 1108 and office 1105, it may be advantageous to provide two or more DAE's as illustrated. Each DAE 1110 or 1112 may include an IR detector and controller as described hereinabove, including with respect to FIGS. 8A-8C and 10A-10C, for example. Each respective IR detector of the DAEs may be capable of low resolution IR imaging within a respective field of view. In a real office corresponding to representation 1100, IR properties may be measured initially and/or periodically during times when the office is unoccupied to establish a baseline IR image of the office to which subsequent images of the as-occupied space may be compared.

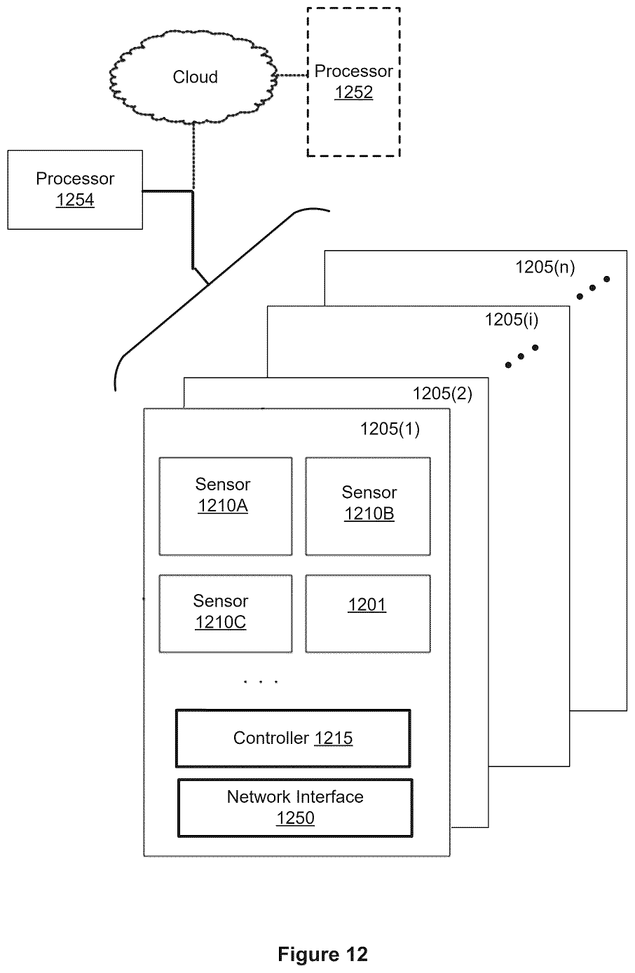

In some implementations, one or more occupancy sensing systems, whether or not configured within respective DAEs, are coupled to a processor, directly and/or via the Cloud. Referring now to FIG. 12, an example of a plurality of DAEs 1205 is illustrated, more particularly, a first DAE 1205(1), a second DAE 1205(2) an i^{th} DAE 125(i) and an n^{th} DAE 125(n) where ‘n’ may be 10, 100, 1000 or 10000, for example and ‘i’ is any integer between 2 and ‘n’. Each DAE includes an IR detector 1201, but may, optionally include other sensors, identified as optional sensors 1210A, 1210B, and 1210C. The other sensors may include optical sensors/cameras, acoustic sensors/microphones, and/or air quality sensors, for example. Any

DAE 1205(i) may include an ensemble of sensors organized into a sensor module and may include at least 1, 2, 4, 5, 8, 10, 20, 50, or 500 sensors. The sensor module may include a number of sensors in a range between, for example about 1 to about 1000, from about 1 to about 500, or from about 500 to about 1000). Sensors of a sensor module may comprise sensors configured or designed for sensing a parameter comprising, temperature, humidity, carbon dioxide, particulate matter (e.g., between 2.5 μm and 10 μm), total volatile organic compounds (e.g., via a change in a voltage potential brought about by surface adsorption of volatile organic compound), ambient light, audio noise level, pressure (e.g. gas, and/or liquid), acceleration, time, radar, lidar, radio signals (e.g., ultra-wideband radio signals), passive infrared, glass breakage, or movement detectors. Any DAE 1205(i) may also include non-sensor devices (e.g., emitters), such as buzzers and light emitting diodes. Examples of sensor ensembles and their uses can be found in U.S. patent application Ser. No. 16/447,169, filed Jun. 20, 2019, titled, “SENSING AND COMMUNICATIONS UNIT FOR OPTICALLY SWITCHABLE WINDOW SYSTEMS,” that is incorporated herein by reference in its entirety.

In some embodiments, a DAE 1205(i) may include a transceiver or a sensor coupled with a transceiver. In some embodiments, such a transceiver may be configured to transmit and receive one or more signals using a personal area network (PAN) standard, for example such as IEEE 802.15.4. In some embodiments, signals may comprise Bluetooth, Wi-Fi, or EnOcean signals (e.g., wide bandwidth). The one or more signals may comprise ultra-wide bandwidth (UWB) signals (e.g., having a frequency in the range from about 2.4 to about 10.6 Giga Hertz (GHz), or from about 7.5 GHz to about 10.6 GHZ). An Ultra-wideband signal can be one having a fractional bandwidth greater than about 20%. An ultra-wideband (UWB) radio frequency signal can have a bandwidth of at least about 500 Mega Hertz (MHz). The one or more signals may use a very low energy level for short-range. Signals (e.g., having radio frequency) may employ a spectrum capable of penetrating solid structures (e.g., wall, door, and/or window). Low power may be of at most about 25 milli Watts (mW), 50 mW, 75 mW, or 100 mW. Low power may be any value between the aforementioned values (e.g., from 25 mW to 100 mW, from 25 mW to 50 mW, or from 75 mW to 100 mW). The sensor and/or transceiver may be configured to support wireless technology standard used for exchanging data between fixed and mobile devices, e.g., over short distances. The signal may comprise Ultra High Frequency (UHF) radio waves, e.g., from about 2.402 gigahertz (GHz) to about 2.480 GHz. The signal may be configured for building personal area networks (PANs).

In some embodiments, the device is configured to enable geo-location technology (e.g., global positioning system (GPS), Bluetooth (BLE), ultrawide band (UWB) and/or dead-reckoning). The geo-location technology may facilitate determination of a position of signal source (e.g., location of the tag) to an accuracy of at least 100 centimeters (cm), 75 cm, 50 cm, 25 cm, 20 cm, 10 cm, or 5 cm. In some embodiments, the electromagnetic radiation of the signal comprises ultra-wideband (UWB) radio waves, ultra-high frequency (UHF) radio waves, or radio waves utilized in global positioning system (GPS). In some embodiments, the electromagnetic radiation comprises electromagnetic waves of a frequency of at least about 300 MHz, 500 MHz, or 1200 MHz. In some embodiments, the signal comprises location and/or time data. In some embodiments, the geo-location technology comprises Bluetooth, UWB, UHF, and/or global positioning system (GPS) technology. In some embodiments, the signal has a spatial capacity of at least about 1013 bits per second per meter squared (bit/s/m²).

In some embodiments, pulse-based ultra-wideband (UWB) technology (e.g., ECMA-368, or ECMA-369) is a wireless technology for transmitting large amounts of data at low power (e.g., less than about 1 millivolt (mW), 0.75 mW, 0.5 mW, or 0.25 mW) over short distances (e.g., of at most about 300 feet (′), 250′, 230′, 200′, or 150′). A UWB signal can occupy at least about 750 MHz, 500 MHz, or 250 MHz of bandwidth spectrum, and/or at least about 30%, 20%, or 10% of its center frequency. The UWB signal can be transmitted by one or more pulses. A component broadcasts digital signal pulses may be timed (e.g., precisely) on a carrier signal across a number of frequency channels at the same time. Information may be transmitted, e.g., by modulating the timing and/or positioning of the signal (e.g., the pulses). Signal information may be transmitted by encoding the polarity of the signal (e.g., pulse), its amplitude and/or by using orthogonal signals (e.g., pulses). The UWB signal may be a low power information transfer protocol. The UWB technology may be utilized for (e.g., indoor) location applications. The broad range of the UWB spectrum comprises low frequencies having long wavelengths, which allows UWB signals to penetrate a variety of materials, including various building fixtures (e.g., walls). The wide range of frequencies, e.g., including the low penetrating frequencies, may decrease the chance of multipath propagation errors (without wishing to be bound to theory, as some wavelengths may have a line-of-sight trajectory). UWB communication signals (e.g., pulses) may be short (e.g., of at most about 70 cm, 60 cm, or 50 cm for a pulse that is about 600 MHz, 500 MHz, or 400 MHz wide; or of at most about 20 cm, 23 cm, 25 cm, or 30 cm for a pulse that is has a bandwidth of about 1 GHz, 1.2 GHz, 1.3 GHZ, or 1.5 GHZ). The short communication signals (e.g., pulses) may reduce the chance that reflecting signals (e.g., pulses) will overlap with the original signal (e.g., pulse).

In some embodiments, an increase in the number and/or types of sensors may be used to increase a probability that one or more measured property is accurate and/or that a particular event measured by one or more sensor has occurred. In some embodiments, sensors of sensor ensemble may cooperate with one another. In an example, a radar sensor of sensor ensemble may determine presence of a number of individuals in an enclosure. A processor (e.g., processor 915) may determine that detection of presence of a number of individuals in an enclosure is positively correlated with an increase in carbon dioxide concentration. In an example, the processor-accessible memory may determine that an increase in detected infrared energy is positively correlated with an increase in temperature as detected by a temperature sensor. In some embodiments, network interface (e.g., 1250) may communicate with other sensor ensembles similar to sensor ensemble. The network interface may additionally communicate with a controller.

Each DAE 1205(i) may comprise a respective dedicated controller 1215 to which IR detector 1201 is operatively coupled. When, as illustrated with respect to DAE (1), the DAE 1205(i) includes one or more other sensors (e.g., sensor 1210A, 1210B 1210C), such sensor(s) may also be operatively coupled with the respective controller 1215. Alternatively or in addition, one or more sensors may utilize a remote processor (e.g., 1254) utilizing a wireless and/or wired communications link. Likewise, the one or more sensors may utilize at least one processor (e.g., processor 1252), which may represent a cloud-based processor coupled to the DAE 1205(i) via the cloud. Processors (e.g., 552 and/or 554) may be located in the same building, in a different building, in a building owned by the same or different entity, a facility owned by the manufacturer of the window/controller/DAE, or at any other location. Processors (e.g., 552 and/or 554) may be communicatively coupled with the DAEs 1205(i) by way of respective network interfaces 1250. In some embodiments, onboard processing and/or memory of one or more DAEs 1205(i) may be used to support other functions (e.g., via allocation of ensembles(s) memory and/or processing power to the network infrastructure of a building).

As indicated hereinabove, the present occupancy determination techniques do not require a high resolution IR detector. Moreover, it is preferred that determined occupancy data (determined by controller 1215, for example) exclude personally identifiable information (PII) of occupants. To that end, IR detector 1201 may be selected to have a low resolution, e.g., no greater than 100×100 pixels per 1000 square feet of a viewable area within the field of view of the IR detector 1201. Alternatively or in addition, the controller 1215 may be configured to identify PII detected from a higher resolution IR detector and/or any of the sensors 1210A, 1210B or 1210C. In such embodiments, the controller 1215 may be further configured to delete, mask or otherwise prevent PII from being forwarded from the DAE 1205(i) to external processors, e.g., processor 1254 or 1252.

One or both of processors 1254 of 1252 may be part of or coupled with a Building Management System (BMS), not illustrated. The BMS may be configured to receive and process determined occupancy data from any number of DAEs 1205 in order to monitor occupancy of multiple spaces within a building and to manage other building systems (e.g., lighting, HVAC, security) responsive to the received occupancy data. For example, an increased occupancy level may be correlated with a need to increase airflow and/or lower a thermostat setting. As a further example, in one use case scenario, because room cleanliness may have an inverse relationship to the number of person-hours accumulated between room cleanings, a determination may be made to increase the cleaning frequency of spaces found to exhibit relatively high occupant density.

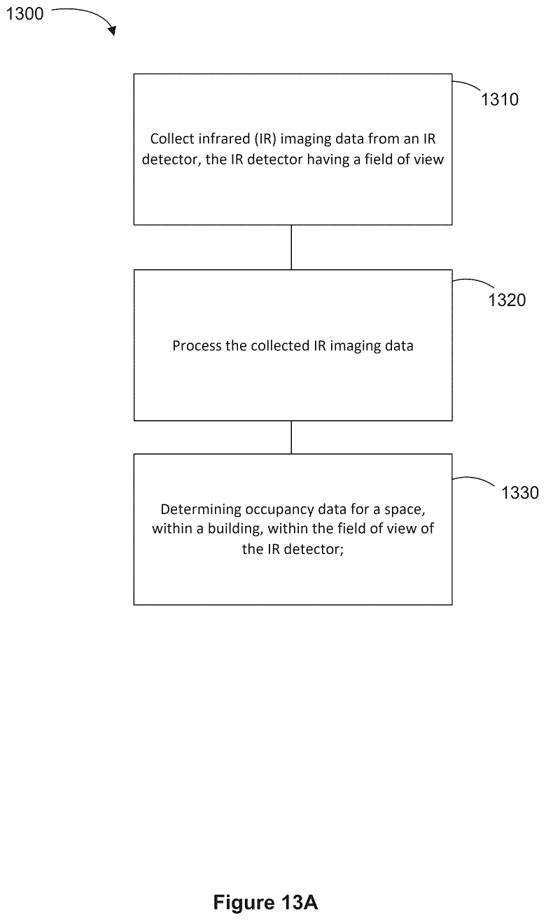

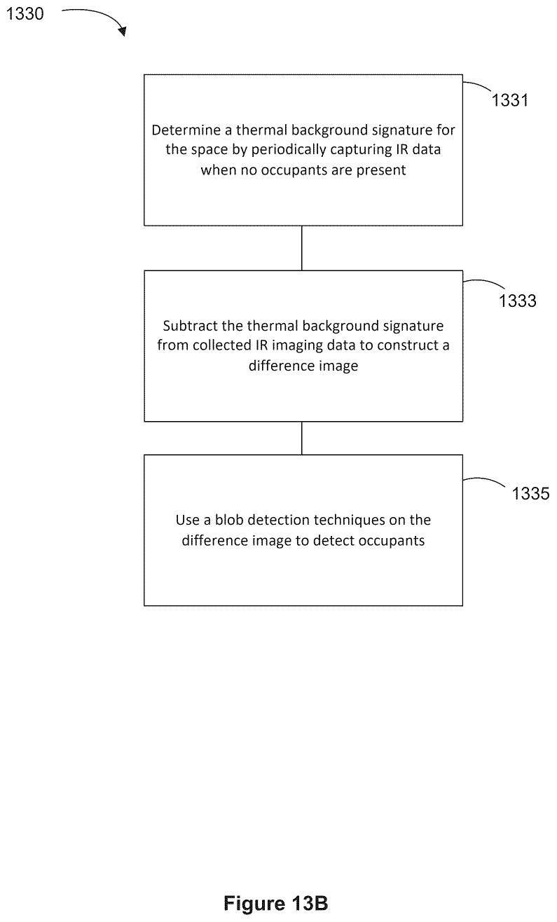

FIGS. 13A and 13 B illustrates a process flow diagram for determining occupancy data, according to an embodiment. Referring first to FIG. 13A, according to the illustrated example method 1300, infrared (IR) imaging data is collected, block 1310, from an IR detector, the IR detector having a field of view. At block 1320, the collected IR imaging data is processed. The collected IR imaging data may be processed by a controller associated with the IR detector as described hereinabove. Moreover the IR detector and associated controller may be included in a digital architectural element.

At block 1330, occupancy data for a space within a building, within the field of view of the IR detector may be determined. Advantageously, the determined occupancy data excludes personally identifiable information (PII) of any occupant in the space.

Referring now to FIG. 13B, determining block 1330, is shown, in some embodiments, to include sub-processes identified as blocks 1331, 1333 and 1335. At block 1331, a thermal background signature for the space may be determined by periodically capturing IR data when no occupants are present. At block 1333, the thermal background signature may be subtracted from collected IR imaging data to construct a difference image. At block 1335, blob detection techniques may be used on the difference image to detect occupants.

### Enterprise Communication/Networking Components

As indicated above, the disclosed occupancy determination techniques may advantageously be used in connection with window systems and associated components. Such window systems and associated components may be configured to facilitate high bandwidth (e.g., gigabit) communication and associated data processing. These communications and data processing may employ optically switchable window systems components and facilitate various window and non-window functions as described herein and in U.S. patent application Ser. No. 16/447,169, filed Jun. 20, 2019, PCT Patent Application No. PCT/US18/29476, filed Apr. 25, 2018, U.S. Patent Application No. 62/666,033, filed May 2, 2018, and PCT Patent Application No. PCT/US18/29406, filed Apr. 25, 2018 each of which applications are hereby incorporated by reference in their entireties for all purposes.

Example components for enhancing functionality of a communications network that serves optically switchable windows may include a digital element having sensors, display drivers, and logic for various functions that employ high data rate processing, the digital element configured, for example, as a digital wall interface or a digital architectural element such as a digital mullion; and an enhanced functionality window controller that includes an access point for wireless communication, e.g., a Wi-Fi access point.

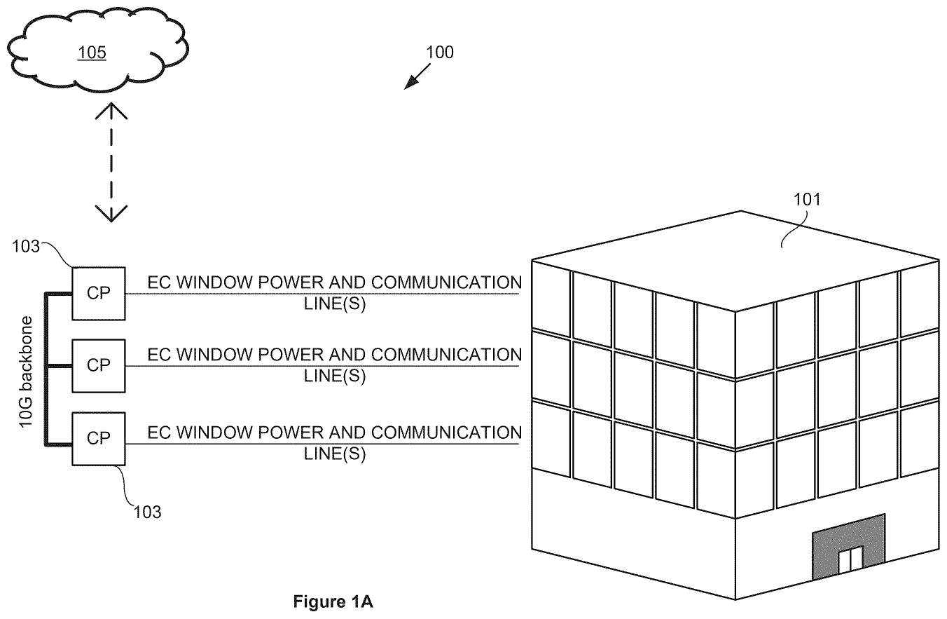

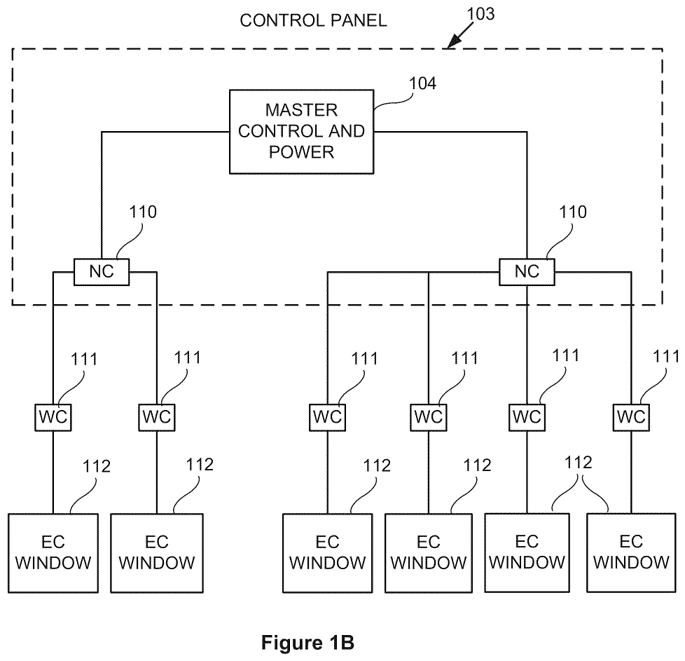

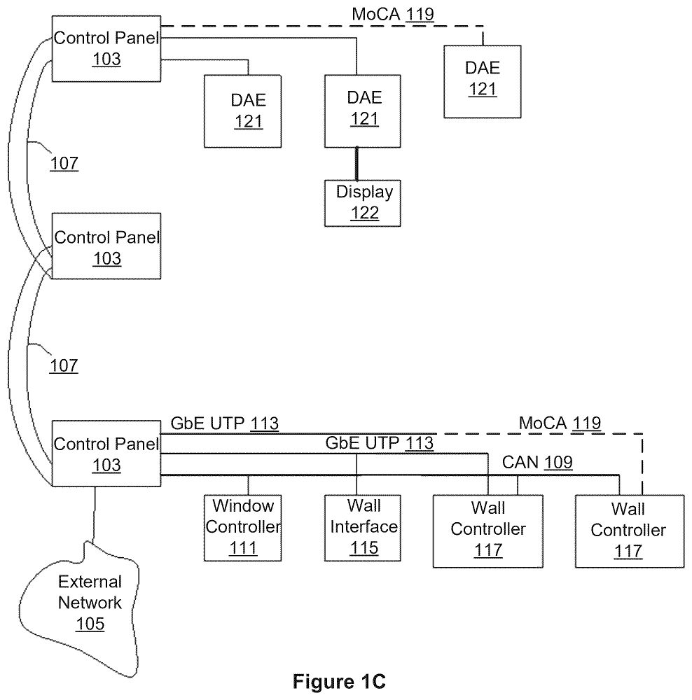

FIGS. 1A through 1C show various link technologies and topologies adapted to power and control electrochromic (EC) windows or other types of optically switchable windows. FIG. 1A presents a highly simplified top level view of a system 100 that includes a building 101 that includes a number of EC windows. A subset of the EC windows is connected by way of EC window power and communications lines to a “Control Panel” (CP) 103. Control panels will be described in more detail hereinbelow. In the illustrated example, three the building's windows are grouped in three subsets, each connected to a respective CP 103, but it will be appreciated that fewer or more than three CP's may be contemplated for any given building. In the illustrated example, the three CPs 103 are communicatively coupled by a high bandwidth 10 Gbps backbone, and to an external network 105.

FIG. 1B illustrates a more detailed block diagram of a control panel 103 interfacing with a plurality of EC windows 112. In the illustrated example the control panel 103 includes a master control and power module 104 and to network controllers (NC's) 110. It will be appreciated that the control panel 103 may include fewer or more NC's 110 than illustrated. Each NC 110 is competitively coupled with two or more window controllers (WC's) 111, each window controller 111 being associated with a respective EC window 112.

While FIGS. 1A and 1B show only conventional window controllers, the links may also provide data transmission to other elements such as digital wall interfaces, enhanced functionality window controllers, digital architectural elements, and the like. FIG. 1C shows an example of a data communication system that can provide data for interacting with optically switchable windows and for non-window purposes. As depicted, a building's communication system has multiple control panels (CPs) 103, with at least one connected to an external network 105 such as the Internet, which may allow access to a variety of services and/or content, such as cloud-based services and/or content. Each control panel 103 may contain components for delivering power to one or more window controllers and/or other devices in the building and a master or network controller as described elsewhere herein. Example features of control panels and their components are provided in U.S. patent application Ser. No. 15/365,685, filed Nov. 30, 2016, hereby incorporated by reference. In the depicted embodiment, each control panel 103 also has a high bandwidth data communications switch such as a 10 gigabit per second (Gbps) Ethernet switch.

Each control panel 103 is linked to one or more other control panels via appropriate cabling 107 to create a data network backbone. In certain embodiments, cabling 107 includes twinaxial cabling, which may employ copper conductors in an insulating shield. Twinaxial cable is suitable for communication distances of a few hundred feet. In certain embodiments, high bandwidth, e.g., 2.5 Gbps and beyond, coaxial is used. Current and evolving implementations of MoCA data transmission protocols support this. Still further, in some cases, particularly those requiring only relatively short links, an unshielded twisted pair cable may be used. Certain embodiments employ high bandwidth (e.g., 10 Gbps or greater) wireless connections. These embodiments may employ sets of parabolic antennas and parabolic receivers.

Various types of data transmission lines may be employed to provide data communications between the control panels 103 and destination devices in the building such as optically switchable windows and/or non-window devices in a building. In the depicted embodiment, a data transmission line 109 and associated interfaces supports a controller network protocol such as the Controller Area Network (CAN) protocol CAN 2.0. In the depicted embodiment, transmission line 109 and associated interfaces provide data communications between conventional window controllers 111 and other types of controllers in the control panels 103. Examples of such other controllers include network and master controllers. Data transmission lines 109 may be employed to provide communications to other devices (not shown) that can function using data provided with the bandwidth limitations of a controller area network.

Another type of data transmission line is a high bandwidth network line 113 such as a gigabit Ethernet (GbE) line, which may be a UTP line (as illustrated), or a twinaxial line, etc. High bandwidth lines 113 can provide data links between control panels 103 and one or more types of devices that may require high data rates for certain functions. In the depicted embodiment, such devices include digital wall interfaces 115 and enhanced functionality window controllers 117, both described elsewhere herein. In some implementations, enhanced functionality window controllers 117 are connected to both a controller network (e.g., controller network line/CAN bus 109) and a high bandwidth line 113.

In the depicted embodiment, high bandwidth data transmission may be provided by either or both of an unshielded twisted pair line supporting gigabit Ethernet and one or more of coaxial lines 119. In some embodiments, data transmission over the coaxial line(s) 119 may be in accordance with a protocol such as that promulgated by the Multimedia over Coax Alliance (MoCA) that functionally bonds channels in a coaxial cable, each channel carrying a different frequency band, into a single combined line that has high bandwidth, e.g., of about 1 Gbps or higher. MoCA protocols are described elsewhere herein. Other link technology such as wireless may be used in place of or to supplement the UTP or coaxial lines.

As depicted, a top control panel 103 serves three digital architectural elements (digital mullions 121 in this case, with one connected to a video display device 122). Either or both GbE UTP lines 113 and coaxial cable 119 may be employed to provide high bandwidth data communication between the control panel and the digital architectural elements.

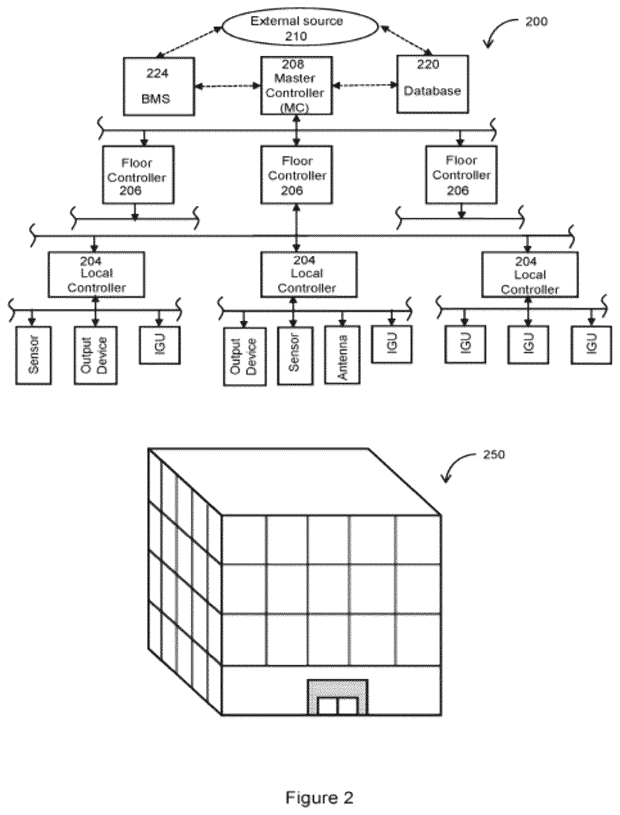

FIG. 2 shows an example of a control system architecture 200 comprising a master controller 208 that controls intermediate (e.g., floor) controllers 206, that in turn control local controllers 204. In some embodiments, a local controller controls one or more integrated glass units (IGUs), one or more sensors, one or more output devices (e.g., one or more emitters), one or more antennas, or any combination thereof. FIG. 2 shows an example of a configuration in which the master controller is operatively coupled (e.g., wirelessly and/or wired) to a building management system (BMS) 224 and to a database 220. Arrows in FIG. 2 represent communication pathways. A controller may be operatively coupled (e.g., directly/indirectly and/or wired and wirelessly) to an external source 210. The external source may comprise a network. The external source may comprise one or more sensor or output devices. The external source may comprise a cloud-based application and/or database. The communication may be wired and/or wireless. The external source may be disposed external to the facility. For example, the external source may comprise one or more sensors and/or antennas disposed, e.g., on a wall or on a ceiling of the facility. The communication may be mono-directional or bidirectional. In the example shown in FIG. 2, all communication arrows are meant to be bidirectional.

### Multi-Component Digital Elements on Building Elements

As indicated above, a high bandwidth network as described herein may include a plurality of digital elements with robust sensing and data processing capabilities and/or one or more additional features such as data storage and/or user interface capabilities. Components enabling these capabilities are described below and may be referred to herein, generally as “sensors and other peripheral” components or elements. Uses and functions of digital elements are also described below.

As explained below, digital elements may be provided in various formats and housings that allow, as the purpose dictates, installation on building structural elements, which are typically permanent elements, and/or on building walls, floors, ceilings, or roofs. In various embodiments, the chassis or housing of a digital element is no greater than about 5 meters in any dimension, or no greater than about 3 meters in any dimension. In various embodiments, the housing is rigid or semi-rigid and encompasses some or all components of the element. In some cases, the housing provides a frame or scaffold for attaching one or more components such as a speaker, a display, an antenna, or a sensor. In some embodiments, the housing provides external access to one or more ports or cables such as ports or cables for attaching to network links, video displays, mobile electronic devices, battery chargers, etc.

Window controller networks and associated digital elements may be installed relatively early in the construction of office buildings and other types of buildings. Frequently, the window controller network is installed before any other network, e.g., before networks for other building functions such as Building Management Systems (BMSs), security systems, Information Technology (IT) systems of tenants, etc.

In the absence of the present teachings, the sensors and other peripheral elements are designed around the walls and ceilings of the building after the construction and as a result may be costly to install, operate and maintain. In certain embodiments of this disclosure, a high bandwidth window network and associated digital components are installed early and provide associated sensors and peripherals in the skin or fabric of the building (e.g., structural building components, particularly those on the perimeter of the building or rooms such as walls, partitions, frames, beams, mullions, transoms, and the like). The installation may occur during building construction. The installed network may utilize remote operational capabilities of a window network (e.g., sensing, data transmission, processing) to reduce the installation and operating costs of sensors, which are currently silo-ed, and edge network technologies.

Regarding operating costs, managing and operating silo-ed sensor networks is very expensive. In certain embodiments, a high bandwidth building network and associated digital elements facilitate central monitoring and operating of sensors and other peripherals, thereby significantly reduces the operating cost of sensor networks.

In certain embodiments, sensors on a window network are installed close to where building occupants spend their time, thereby improving the sensors' effectiveness in providing occupant comfort. As discussed below, digital elements as described herein that are connected to a high bandwidth network may be deployed in various locations throughout a building. Examples of such locations include building structural elements in offices, lobbies, mezzanines, bathrooms, stairwells, terraces, and the like. Within any of these locations, digital elements may be positioned and/or oriented proximate to occupant positions, thereby collecting environment data that is most appropriate for triggering building systems to act in a way maintain or enhance occupant comfort.

### Digital Architectural Element

As described hereinabove, a digital architectural element (DAE) may contain various sensors, a processor (e.g., a microcontroller), a network interface, and one or more peripheral interfaces. For example, a DAE may include an IR detector and a controller configured to determine occupancy data, as described hereinabove. DAE sensors may also include light sensors, optionally including image capture sensors such as cameras, audio sensors such as voice coils or microphones, air quality sensors, and proximity sensors (e.g., certain IR and/or RF sensors). The network interface may be a high bandwidth interface such as a gigabit (or faster) Ethernet interface. Examples of DAE peripherals include video display monitors, add-on speakers, mobile devices, battery chargers, and the like. Examples of peripheral interfaces include standard Bluetooth modules, ports such as USB ports and network ports, etc. In addition or alternatively, ports include any of various proprietary ports for third party devices.

In certain embodiments, the digital architectural element works in conjunction with other hardware and software provided for an optically switchable window system (e.g., a display on window). In certain embodiments, the digital architectural element includes a window controller or other controller such as a master controller, a network controller, etc.

In certain embodiments, a digital architectural element includes one or more signal generating devices such as a speaker, a light source (e.g., and LED), a beacon, an antenna (e.g., a Wi-Fi or cellular communications antenna), and the like. In certain embodiments, a digital architectural element includes an energy storage component and/or a power harvesting component. For example, an element may contain one or more batteries or capacitors as energy storage devices. Such elements may additionally include a photovoltaic cell. In one example, a digital architectural element has one or more user interface components (e.g., a microphone or a speaker), and one more sensors (e.g., a proximity sensor), as well as a network interface for high bandwidth communications.

In various embodiments, a digital architectural element is designed or configured to attach to or otherwise be collocated with a structural element of building. In some cases, a digital architectural element has an appearance that blends in with the structural element with which it is associated. For example, a digital architectural element may have a shape, size, and color that blends with the associated structural element. In some cases, a digital architectural element is not easily visible to occupants of a building; e.g., the element is fully or partially camouflaged. However, such element may interface with other components that do not blend in such as video display monitors, touch screens, projectors, and the like.

The building structural elements to which digital architectural elements may be attached include any of various building structures. In certain embodiments, building structures to which digital architectural elements attach are structures that are installed during building construction, in some cases early in building construction. In certain embodiments, the building structural elements for digital architectural elements are elements that serve as a building structural function. Such elements may be permanent, i.e., not easy to remove from a building.

Examples include walls, partitions (e.g., office space partitions), doors, beams, stairs, façades, moldings, mullions and transoms, etc. In various examples, the building structural elements are located on a building or room perimeter. In some cases, digital architectural elements are provided as separate modular units or boxes that attach to the building structural element. In some cases, digital architectural elements are provided as façades for building structural elements. For example, a digital architectural element may be provided as a cover for a portion of a mullion, transom, or door. In one example, a digital architectural element is configured as a mullion or disposed in or on a mullion. If it is attached to a mullion, it may be bolted on or otherwise attached to the rigid parts of the mullion. In certain embodiments, a digital architectural element can snap onto a building structural element. In certain embodiments, a digital architectural element serves as a molding, e.g., a crown molding. In certain embodiments, a digital architectural element is modular; i.e., it serves as a module for part of a larger system such as a communications network, a power distribution network, and/or computational system that employs an external video display and/or other user interface components.

In some embodiments, the digital architectural element is a digital mullion designed to be deployed on some but not all mullions in a room, floor, or building. In some cases, digital mullions are deployed in a regular or periodic fashion. For example, digital mullions may be deployed on every sixth mullion.

In certain embodiments, in addition to the high bandwidth network connection (port, switch, router, etc.) and a housing, the digital architectural element includes multiple of the following digital and/or analog components: a camera, a proximity or movement sensor, an occupancy sensor, a color temperature sensor, a biometric sensor, a speaker, a microphone, an air quality sensor, a hub for power and/or data connectivity, display video driver, a Wi-Fi access point, an antenna, a location service via beacons or other mechanism, a power source, a light source, a processor and/or ancillary processing device.

One or more cameras may include a sensor and processing logic for imaging features in the visible, IR (see use of thermal imager below), or other wavelength region; various resolutions are possible including HD and greater.

One or more proximity or movement sensors may include an infrared sensor, e.g., an IR sensor. In some embodiments, a proximity sensor is a radar or radar-like device that detects distances from and between objects using a ranging function. Radar sensors can also be used to distinguish between closely spaced occupants via detection of their biometric functions, for example, detection of their different breathing movements. When radar or radar-like sensors are used, better operation may be facilitated when disposed unobstructed or behind a plastic case of a digital architectural element.

As describe above, a DAE may be or include an occupancy sensor including an IR detector, data from which, when processed with an appropriate computer implemented algorithm, can be used to detect and/or count the number of occupants in a room. In one embodiment, data from a thermal imager or thermal camera is correlated with data from a radar sensor to provide a better level of confidence in a particular determination being made. In embodiments, thermal imager measurements can be used to evaluate other thermal events in a particular location, for example, changes in air flow caused by open windows and doors, the presence of intruders, and/or fires.

One or more color temperature sensors may be used to analyze the spectrum of illumination present in a particular location and to provide outputs that can be used to implement changes in the illumination as needed or desired, for example, to improve an occupant's health or mood.

One or more biometric sensors (e.g., for fingerprint, retina, or facial recognition) may be provided as a stand-alone sensor or be integrated with another sensor such as a camera.

One or more speakers and associated power amplifiers may be included as part of a digital architectural element or separate from it. In some embodiments, two or more speakers and an amplifier may, collectively, be configured as a sound bar; i.e., a bar-shaped device containing multiple speakers. The device may be designed or configured to provide high fidelity sound.

One or more microphones and logic for detecting and processing sounds may be provided as part of a digital architectural element or separate from it. The microphones may be configured to detect one or both of internally or externally generated sounds. In one embodiment, processing and analysis of the sounds is performed by logic embodied as software, firmware, or hardware in one or more digital structural element and/or by logic in one or more other devices coupled to the network, for example, one or more controllers coupled to the network. In one embodiment, based on the analysis, the logic is configured to automatically adjust a sound output of one or more speaker to mask and/or cancel sounds, frequency variations, echoes, and other factors detected by one or more microphone that negatively impact (or potentially could negatively impact) occupants present in a particular location within a building. In one embodiment, the sounds comprise sounds generated by, but not limited to: indoor machinery, indoor office equipment, outdoor construction, outdoor traffic, and/or airplanes.

In embodiments, one or more microphones are positioned on, or next to, windows of a building; on ceilings of the building; and/or or other interior structures of the building. The logic may be configured in a singular or arrayed fashion to analyze and determine the type, intensity, spectrum, location and/or direction interior sounds present in a building. In one embodiment, the logic is functionally connected to other fixed or moving network connected devices that may be being used in a building, for example, devices such as computers, smart phones, tablets, and the like, and is configured to receive and analyze sounds or related signals from such devices.

In one embodiment, the logic is configured to measure and analyze real time delays in signals from microphones to predict the amount and type of sound needed to mask or cancel unwanted external and/or internal sound present at a particular location in the building. In one embodiment, the logic is configured to detect changes in the level and/or location of the unwanted external and/or internal sound where, for example, the changes can be caused by movements of objects and people within and outside a building, and to dynamically adjust the amount of the masking and/or canceling sound based on the changes. In one embodiment, the logic is configured to use signals from tracking sensors in a building and, according to the signals, to cause the masking and/or canceling sounds to be increased or decreased at a particular location in the building according to a presence and/or location of one or more occupant. In one embodiment, one or more of the speakers are positioned to generate masking and/or canceling sounds that propagate substantially in a plane of travel of unwanted sound, including in a horizontal plane, vertical plane, and/or combinations of the two.

In one embodiment, the logic comprises an algorithm designed to acoustically map an interior of a building, to locate in-office noise source locations, and to improve speech privacy. In one embodiment, after an array of speakers and microphones is installed in a building, the logic may be used to perform an acoustical sweep so as to cause each speaker to generate sound that in turn is detected by each microphone. In one embodiment, time delays, sound level decreases, and spectrum differences in the detected sounds are used to calculate and map effective acoustical distances between speakers, microphones, and between them. In one embodiment, an acoustical transfer function of an interior of a building map may be obtained from the acoustical sweep. With such an acoustical map and set of transfer functions of one or more space within a building, the logic can make appropriate masking and/or canceling level determinations when sources of unwanted sounds generated in the spaces are present. When needed, the logic can adjust speaker generated sounds to correct for absorption of certain absorptive surfaces, for example, a sound that may otherwise be sound muffled bouncing off of a soft partition can be adjusted to sound crisp again. The acoustical map of a space can also be used to determine what is direct versus indirect sound, and adjust time delays of masking and/or canceling sounds so that they arrive at a desired location at the same time.

One or more air quality sensor s (optionally able to measure one or more of the following air components: volatile organic compounds (VOC), carbon dioxide temperature, humidity) may be used in conjunction with HVAC to improve air circulation control.

One or more hubs for power and/or data connectivity to sensor(s), speakers, microphone, and the like may be provided. The hub may be a USB hub, a Bluetooth hub, etc. The hub may include one or more ports such as USB ports, High Definition Multimedia Interface (HDMI) ports, etc. Alternatively or in addition, the element may include a connector dock for external sensors, light fixtures, peripherals (e.g., a camera, microphone, speaker(s)), network connectivity, power sources, etc.

One or more video drivers for a display (e.g., a transparent OLED device) on or proximate to an integrated glass unit (IGU) associated with the architectural element may be provided. The driver may be wired or optically coupled; e.g., the optical signal is launched into the window by optical transmission; see, e.g., a switchable Bragg grating that includes a display with a light engine and lens that focuses on glass waveguides that transmits through the glass and travels perpendicularly to line of sight.

One or more Wi-Fi access points and antenna(s), which may be part of the Wi-Fi access point or serve a different purpose. In certain embodiments, the architectural element itself or faceplate that covers all or a portion of the architectural element serves as an antenna. Various approaches may be employed to insulate the architectural element and make it transmit or receive directionally. Alternatively, a prefabricated antenna, or a window antenna as described in PCT Patent Application No. PCT/US17/31106, filed May 4, 2017, incorporated herein by reference in its entirety, may be employed.

One or more power sources such as an energy storage device (e.g., a rechargeable battery or a capacitor), and the like may be provided. In some implementations, a power harvesting device is included; e.g., a photovoltaic cell or panel of cells. This allows the device to be self-contained or partially self-contained. The light harvesting device may be transparent or opaque, depending on where it is attached. For example, a photovoltaic cell may be attached to, and partially or fully cover, the exterior of a digital mullion, while a transparent photovoltaic cell may cover a display or user interface (e.g., a dial, button, etc.) on the digital architectural element.

One or more light sources (e.g., light emitting diodes) configured with the processor to emit light under certain conditions such signaling when the device is active.

One or more processors may be configured to provide various embedded or non-embedded applications. The processor may be a microcontroller. In certain embodiments, the processor is low-powered mobile computing unit (MCU) with memory and configured to run a lightweight secure operating system hosting applications and data. In certain embodiments, the processor is an embedded system, system on chip, or an extension.

One or more ancillary processing devices such as a graphical processing unit, or an equalizer or other audio processing device configured to interpret audio signals.

A digital architectural element or building structural element associated with a digital architectural element may have one or more antennas. These may be pre-constructed and attached to or embedded in the element, either on the surface on or in the element's interior. Alternatively, or in addition, an antenna may be configured such that the structure of a digital architectural element or building structural element serves as an antenna component. For example, a conductive metal piece of a mullion may serve as an antenna element or ground plane. In some embodiments, a portion of a digital architectural element or building structural element is removed (or added) so that the remaining portion serves as a tuned antenna element. For example, a part of a mullion may be punched out to provide a tuned antenna element. By attaching coaxial or other cable to the element and an RF transmitter or receiver, the building structural element and/or an associated digital architectural element may serve as an antenna element. The antenna components may be designed with an impedance (e.g., about 50 ohms) that matches that of the RF transmitter, for example.

Depending on construction, the antenna element may be a Wi-Fi antenna, a Bluetooth antenna, a cellular communication antenna, etc. In certain embodiments, the antenna transmits and/or receives in the radio frequency portion of the electromagnetic spectrum. The antenna may be a patch antenna, a monopole antenna, a dipole antenna, etc. It may be configured to transmit or receive electromagnetic signals in any appropriate wavelength range. Examples of antenna components that may be employed in optically switchable window systems are described in PCT Patent Application No. PCT/US17/31106, filed May 4, 2017, which was previously incorporated herein by reference in its entirety.

In various embodiments, a camera of a digital architectural element is configured to capture images in the visible portion of the electromagnetic spectrum. In some cases, the camera provides images in high resolution, e.g., high definition, of at least about 720p or at least about 1080p. In certain cases, the camera may also capture images having information about the intensity of wavelengths outside the visible range. For example, a camera may be able capture infrared signals. In certain implementations, a digital architectural element includes a near infrared device such as a forward looking infrared (FLIR) camera or near-infrared (NIR) camera. Examples of suitable infrared cameras include the Boson™ or Lepton™ from FLIR Systems, of Wilsonville, OR. Such infrared cameras may be employed to augment a visible camera in a digital architectural element.

In certain embodiments, the camera may be configured to map the heat signature of a room such that it may serve as a temperature sensor with three-dimensional awareness. In some implementations, such cameras in a digital architectural element enable occupancy detection, augment visible cameras to facilitate detecting a human instead of a hot wall, provide quantitative measurements of solar heating (e.g., image the floor or desks and see what the sun is actually illuminating), etc.

In certain embodiments, the speaker, microphone, and associated logic are configured to use acoustic information to characterize air quality or air conditions. As an example, an algorithm may issue ultrasonic pulses, and detect the transmitted and/or reflected pulses coming back to a microphone. The algorithm may be configured to analyze the detected acoustic signal, sometimes using a transmitted vs. received differential audio signal, to determine air density, particulate deflection, and the like to characterize air quality.

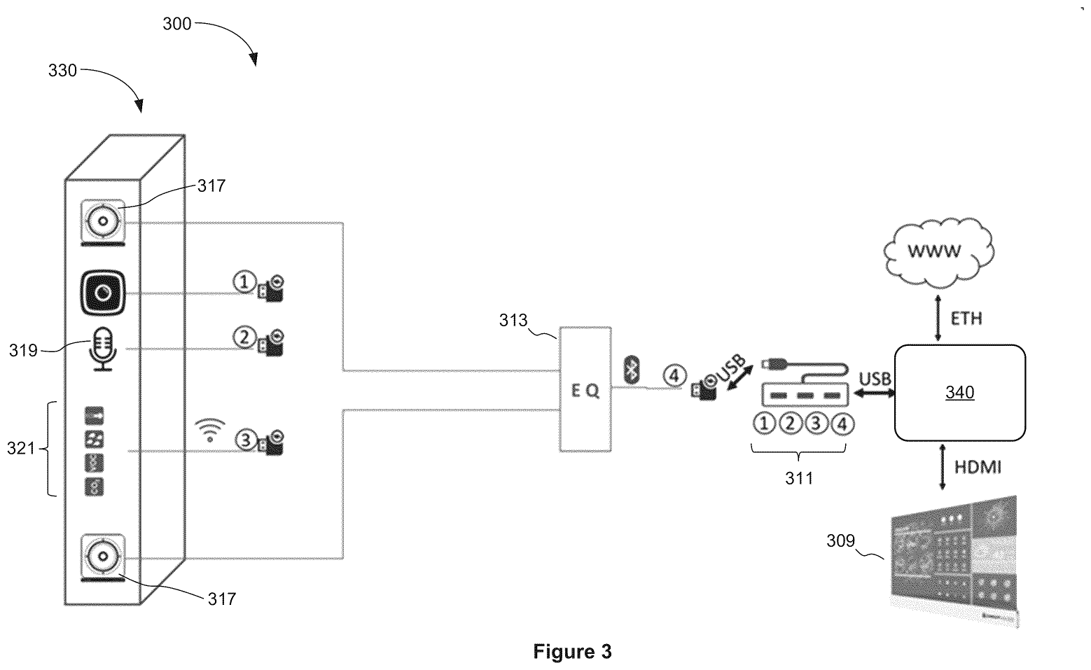

FIG. 3 illustrates a block diagram showing an example of components that may be present in certain implementations of a digital architectural element (DAE). In the illustrated example, an arrangement 300 includes a DAE 330 and a computer or processor 340. The computer processor 340 is connected to an external network such as the internet and optionally a cloud-based content and/or service provider. The connection may include an appropriate modem, router, or switch and may include a high bandwidth backbone such as the 10 G backbone described hereinabove. The computer or processor 340 is also connected to a video display 309 via, in this example, a HDMI link. Further, the computer 340 is connected to ports 311 (USB, Wi-Fi, Bluetooth, or otherwise) to make available additional internal or external resources for the DAE 330. As indicated hereinabove a DAE may include various sensors and peripheral elements. In the example illustrated in FIG. 3, DAE 330 includes speakers 317, microphone 319, and various sensors 321. Any one or more of these components may be coupled to the computer or processor 340 via the ports 311.

In the illustrated example, an equalizer 313 may be configured to provide tone control to adjust for acoustics of a room. In some cases, the equalizer 313 facilitates adjustment of room acoustics using, for example, real time, time delay reflectometry. The equalizer and associated components can thereby compensate for unwanted audio artifacts produced by interactions of the sound waves with items that are in a room or otherwise in close proximity with an occupant. In certain embodiments, a signal pulse is generated by a speaker associated with the digital architectural element, and one or more microphones pick up the pulse directly and as reflected and attenuated by items in the room. Based on the time delay between emitting and detecting the pulse, as well as the tonal quality of the detected pulse, the system can infer room boundaries, etc. In certain embodiments, a user's smart phone further enables optimizing speaker outputs for the acoustical environment of various locations in a room. During a set up mode, the user, with phone enabled, may move around a room and use the phone to detect the acoustical response. Based on the location and the detected acoustic response, the digital architectural element can determine how to optimize speaker output. After the acoustic profile of the room is mapped, the digital architectural element is programmed to tune its speaker output based on various factors such as where the user is located in a room. The element can, in some embodiments, detect the user location using any of a number of proximity techniques, such as those described in PCT Patent Application No. PCT/US17/31106, filed May 4, 2017, which was previously incorporated herein by reference in its entirety.

### Digital Wall Interface

Certain aspects of this disclosure pertain to digital wall interfaces that contain some or all of the components that are used in a digital architectural element, and the digital wall interface is configured to include a chassis or housing that is designed for mounting on a wall or door of a partially or fully constructed building. The wall interface may be constructed to provide a user interface that is easily visible to users. It may have a relatively small footprint (e.g., at most about 500 square inches of user facing surface area) and be circularly or polygonally shaped. In certain embodiments, a digital wall interface is approximately tablet shaped and sized.

In certain embodiments, a digital wall interface has the same or similar features as a digital architectural element but is a wall mounted device. For example, a digital wall interface may include the sensors and peripheral elements as described for the digital architectural element. Further, such elements may be included in a bar or similar chassis.

In various embodiments, a digital architectural element is provided with the building, as the building is being constructed, while a digital wall interface is installed in a building after the building construction is complete or nearly complete. In one approach to building construction, a plurality of digital architectural elements is installed during construction of the basic building structures—walls, partitions, doors, mullions and transoms, etc.—while one or more digital wall interfaces are installed shortly before or at the time of occupancy, e.g., by a tenant. Of course, once installed, the digital wall interfaces and the digital architectural elements can work in conjunction, e.g., as part of a mesh network, by sharing sensed results, by sharing analysis and control logic, etc.

In many embodiments, a digital wall interface includes a built in display configured to provide a user interface, and optionally a touch sensitive interface. In some but not all embodiments, a digital architectural element does not include a display or touch interface. Note that in some embodiments, a digital architectural element does not include a built in display but does have an associated display, e.g., a display connected to the element by an HDMI cable or a projector configured to project video controlled by the element. Similarly, a digital wall interface may be configured to work with a separate display such as a window display or a projection display.

While much of the discussion herein regarding uses, components, and functions of digital devices uses digital architectural elements as examples, in most cases a digital wall interface may serve a similar or identical purpose. So, unless the discussion focuses on a building structural element to which digital device is attached or associated with, the discussion applies equally to digital wall interfaces and digital architectural elements.

### Applications and Uses

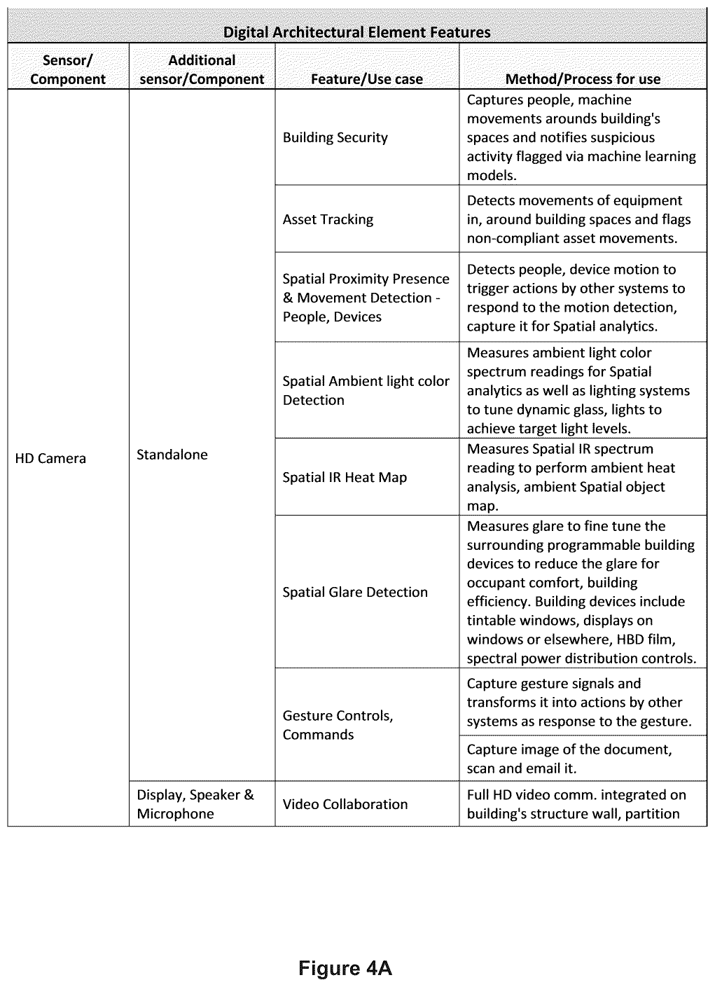

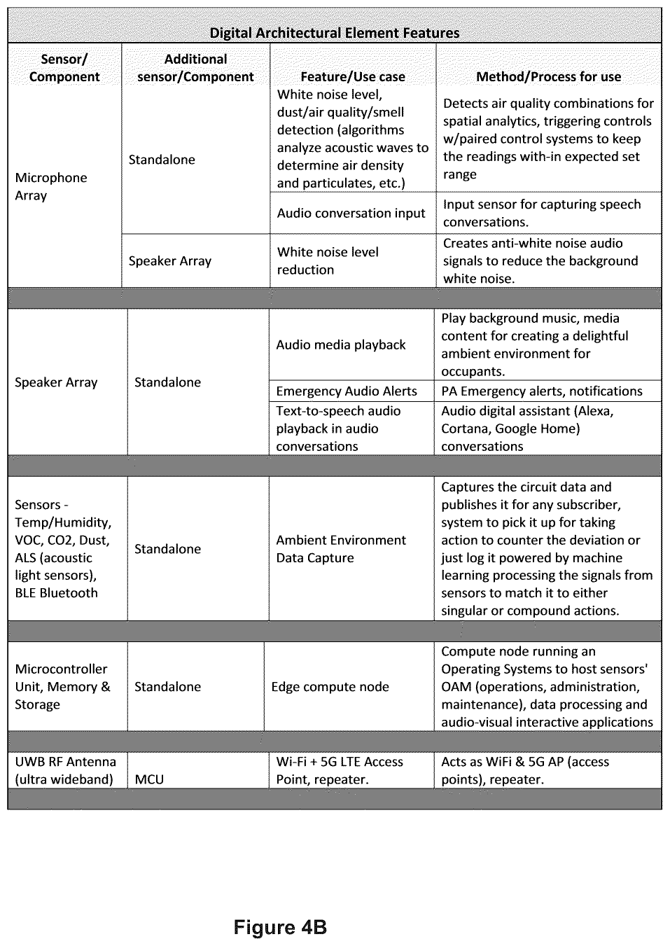

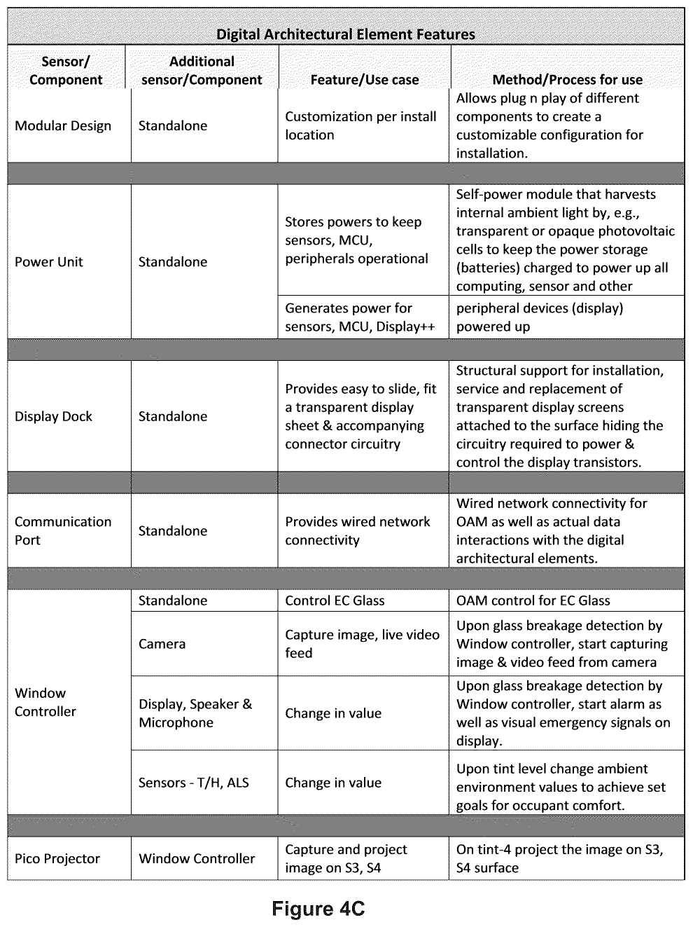

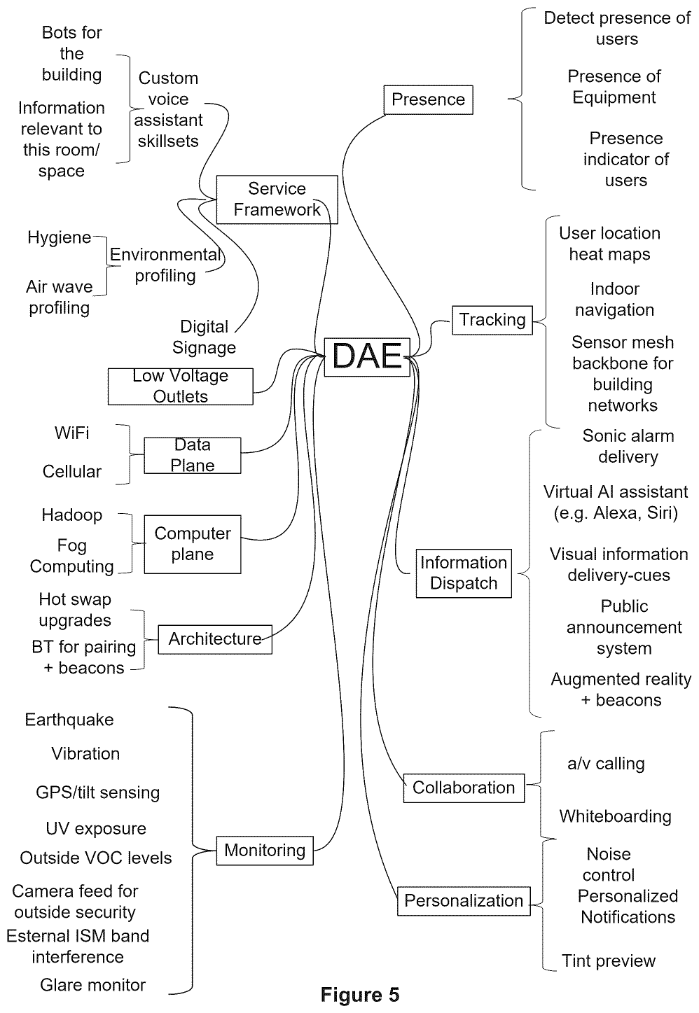

FIGS. 4A through 4C illustrate a number of examples of applications and uses of the digital architectural element and related elements contemplated by the present disclosure. It will be appreciated that the network and high bandwidth backbone described herein may be used for various functions, some of which are not directly related to controlling windows. FIG. 5 illustrates several examples of such functions. One such function is the providing of internet, local network, and/or computational services for tenants or other building occupants, construction personnel on site during the construction of the building, and the like. During construction, the network and computation resources provided by the backbone and digital elements may be used for more than just commissioning windows. For example, they may be used to provide architectural information, construction instructions, and the like. In this way, construction personnel have ready access to construction information they need via a high bandwidth, on-site network.

In some cases, the network, communications, and/or computational services provided by the network and computational infrastructure as described herein are utilized in multi-tenant buildings or shared workspaces such as those provided by WeWork.com. For example, shared workspace buildings need only provide temporary connectivity and processing power as needed. A building network such as described herein affords central control and flexible assignment of computational resources to particular building locations. This flexibility allows assignment of different resources to different tenants.

Readings from sensors in a digital element (e.g., a digital wall interface or a digital architectural element) may provide information about the environment in the vicinity of the digital architectural element. Examples of such sensors include sensors for any one or more of temperature, humidity, volatile organic compounds (VOCs), carbon dioxide, dust, light level, glare, and color temperature. In certain embodiments, readings from one or more such sensors are input to an algorithm that determines actions that other building systems should take to offset the deviation in measured readings to get these readings to target values for occupant's comfort or building efficiency, depending on the contextual index of occupant's presence and other signals.

In certain embodiments, a digital element may be provided on the roof of a building, optionally collocated with a sky sensor or a ring sensor such as described in US Patent Application Publication No. 2017/0122802, published May 4, 2017. Such an element may be outfitted with some or all the features presented elsewhere herein for a digital architectural element. Examples include sensors, antenna, radio, radar, air quality detectors, etc. In some implementations, the digital element on the roof or other building exterior location provides information about air quality; in this way, digital elements may provide information about the air quality both inside and outside. This allows decisions about window tint states and other environmental conditions to be made using a full set of information (e.g., when conditions outside the building are unhealthy (or at least worse than they are inside), a decision may be made prohibit venting air from outside).

In some cases, the light levels, glare, color temperature, and/or other characteristics of ambient or artificial light in a region of building are used to make decisions about whether to change the tint state of an electrochromic device. In certain embodiments, these decisions employ one or more algorithms or analyses as described in U.S. patent application Ser. No. 15/347,677, filed Nov. 9, 2016, and U.S. patent application Ser. No. 15/742,015, a national stage application filed Jan. 4, 2018, which are incorporated herein by reference in their entireties. In one example, tinting decisions are made by using a solar calculator and/or a reflection model in conjunction with an algorithm for interpreting light information from sensors of the digital architectural element. The algorithm may in some cases use information about the presence of occupants, how many there are, and/or where they are located (data that can be obtained with a digital architectural element) to assist in making decisions about whether to tint a window and what tint state should be chosen. In some cases, for purposes of determining appropriate tint states, a digital architectural element is used in lieu of or in conjunction with a sky sensor such as described in U.S. patent application Ser. No. 15/287,646, filed Oct. 6, 2016, and previously incorporated herein by reference in its entirety.

As an example of tint and glare control, sensors in a digital element may provide feedback about local light, temperature, color, glare, etc. in a room or other portion of a building. The logic associated with a digital element may then determine that the light intensity, direction, color, etc. should be changed in the room or portion of a building, and may also determine how to effect such change. A change may be necessary for user comfort (e.g., reduce glare at the user's workspace, increase contrast, or correct a color profile for sensitive users) or privacy or security. Assuming that the logic determines that a change is necessary, it may then send instructions to change one or more lighting or solar components such as optically switchable window tint states, display device output, switched particle device film states (e.g., transparent, translucent, opaque), light projection onto a surface, artificial light output (color, intensity, direction, etc.), and the like. All such decisions may be made with or without assistance from building-wide tint state processing logic such as described in U.S. patent application Ser. No. 15/347,677, filed Nov. 9, 2016, and U.S. patent application Ser. No. 15/742,015, a national stage application filed Jan. 4, 2018, previously incorporated herein by reference in their entireties.

An array of digital architectural elements in a building may form a mesh edge access network enabling interactions between building occupants and the building or machines in the building. When equipped with an appropriate network interface, a digital architectural element and/or a digital wall interface and/or an enhanced functionality window controller can be used as a digital compute mesh network node providing connectivity, communication, application execution, etc. within building structural elements (e.g., mullions) for ambient compute processing. It may be powered, monitoring and controlled in a similar or identical manner as an edge sensor node in a mesh network setup in the buildings. It may be used as gateway for other sensor nodes.

A non-exhaustive list of functions or uses for the high bandwidth window network and associated digital elements contemplated by the present disclosure includes: (a) Speaker phone—a digital wall interface or a digital architectural element may be configured to provide all the functions of a speaker phone; (b) Personalization of space—an occupant's preferences and/or roles may be stored and then implemented in particular locations where the occupant is present. In some cases, the preferences and/or roles are implemented only temporarily, when a user is at a particular location. In some cases, the preferences and/or roles remain in effect so long as the occupant is assigned a work space or living space; (c) Security-track assets, identify unauthorized presence of individuals in defined locations, lock doors, tint windows, untint windows, sound alarms, etc.; (d) Control HVAC, air quality; (e) communication with occupants, including public address notifications for occupants during emergencies; messages may be communicated via speakers in a digital element; (f) collaboration among occupants using live video; (g) Noise cancellation—E.g., microphone detects white noise, and the sound bar cancels the white noise; (h) Connecting to, streaming, or otherwise delivering video or other media content such as television; (i) Enhancements to personal digital assistants such as Amazon's Alexa, Microsoft's Cortana, Google's Google Home, Apple's Siri, and/or other personal digital assistants; (j) Facial or other biometric recognition enabled by, e.g., a camera and associated image analysis logic—determine the identification of the people in a room, not just count the number of people; (k) Detect color—color balancing with room lighting and window tint state; (l) Local environmental conditions detected and/or adjusted. Conditions may be determined using one or more of the following types of sensed conditions, for example: temperature & humidity, volatile organic compounds (VOC), CO₂, dust, smoke and lighting (light levels, glare, color temperature).

### Computational System and Memory Devices

The presently disclosed logic and computational processing resources may be provided within a digital element such as a digital wall interface or a digital architectural element as described herein, and/or it may be provided via a network connection to a remote location such as another building using the same or similar resources and services, servers on the internet, cloud-based resources, etc.

Certain embodiments disclosed herein relate to systems for generating and/or using functionality for a building such as the uses described in the preceding “Applications and Uses” section. A programmed or configured system for performing the functions and uses may be configured to (i) receive input such as sensor data characterizing conditions within a building, occupancy details, and/or exterior environmental conditions, and (ii) execute instructions that determine the effect of such conditions or details on a building environment, and optionally take actions to maintain or change the building environment.

Many types of computing systems having any of various computer architectures may be employed as the disclosed systems for implementing the functions and uses described herein. For example, the systems may include software components executing on one or more general purpose processors or specially designed processors such as programmable logic devices (e.g., Field Programmable Gate Arrays (FPGAs)). Further, the systems may be implemented on a single device or distributed across multiple devices. The functions of the computational elements may be merged into one another or further split into multiple sub-modules. In certain embodiments, the computing system contains a microcontroller. In certain embodiments, the computing system contains a general purpose microprocessor. Frequently, the computing system is configured to run an operating system and one or more applications.

In some embodiments, code for performing a function or use described herein can be embodied in the form of software elements which can be stored in a nonvolatile storage medium (such as optical disk, flash storage device, mobile hard disk, etc.). At one level a software element is implemented as a set of commands prepared by the programmer/developer. However, the module software that can be executed by the computer hardware is executable code committed to memory using “machine codes” selected from the specific machine language instruction set, or “native instructions,” designed into the hardware processor. The machine language instruction set, or native instruction set, is known to, and essentially built into, the hardware processor(s). This is the “language” by which the system and application software communicates with the hardware processors. Each native instruction is a discrete code that is recognized by the processing architecture and that can specify particular registers for arithmetic, addressing, or control functions; particular memory locations or offsets; and particular addressing modes used to interpret operands. More complex operations are built up by combining these simple native instructions, which are executed sequentially, or as otherwise directed by control flow instructions.

The inter-relationship between the executable software instructions and the hardware processor is structural. In other words, the instructions per se are a series of symbols or numeric values. They do not intrinsically convey any information. It is the processor, which by design was preconfigured to interpret the symbols/numeric values, which imparts meaning to the instructions.

The algorithms used herein may be configured to execute on a single machine at a single location, on multiple machines at a single location, or on multiple machines at multiple locations. When multiple machines are employed, the individual machines may be tailored for their particular tasks. For example, operations requiring large blocks of code and/or significant processing capacity may be implemented on large and/or stationary machines.

In addition, certain embodiments relate to tangible and/or non-transitory computer readable media or computer program products that include program instructions and/or data (including data structures) for performing various computer-implemented operations. Examples of computer-readable media include, but are not limited to, semiconductor memory devices, phase-change devices, magnetic media such as disk drives, magnetic tape, optical media such as CDs, magneto-optical media, and hardware devices that are specially configured to store and perform program instructions, such as read-only memory devices (ROM) and random access memory (RAM). The computer readable media may be directly controlled by an end user or the media may be indirectly controlled by the end user. Examples of directly controlled media include the media located at a user facility and/or media that are not shared with other entities. Examples of indirectly controlled media include media that is indirectly accessible to the user via an external network and/or via a service providing shared resources such as the “cloud.” Examples of program instructions include both machine code, such as produced by a compiler, and files containing higher level code that may be executed by the computer using an interpreter.

The data or information employed in the disclosed methods and apparatus is provided in a digital format. Such data or information may include sensor data, building architectural information, floor plans, operating or environment conditions, schedules, and the like. As used herein, data or other information provided in digital format is available for storage on a machine and transmission between machines. Conventionally, data may be stored as bits and/or bytes in various data structures, lists, databases, etc. The data may be embodied electronically, optically, etc.

In certain embodiments, algorithms for implementing functions and uses described herein may be viewed as a form of application software that interfaces with a user and with system software. System software typically interfaces with computer hardware and associated memory. In certain embodiments, the system software includes operating system software and/or firmware, as well as any middleware and drivers installed in the system. The system software provides basic non-task-specific functions of the computer. In contrast, the modules and other application software are used to accomplish specific tasks. Each native instruction for a module is stored in a memory device and is represented by a numeric value.

### Integrated Environmental Monitoring and Control

As described hereinabove, the presently disclosed techniques contemplate a network of digital architectural elements (DAE's) capable of collecting a rich set of data related to environmental, occupancy and security conditions of a building's interior and/or exterior. The digital architectural elements may include optically switchable windows and/or mullions or other architectural features associated with optically switchable windows. Advantageously, the digital architectural elements may be widely distributed throughout all or much of, at least, a building's perimeter. As a result, the collected data may provide a highly granular, detailed representation of environmental, occupancy and security conditions associated with much or all of a building's interior and/or exterior. For example, many or all of the building's windows may include, or be associated with, a digital architectural element that includes a suite of sensors such as light sensors and/or cameras (visible and/or IR), acoustic sensors such as microphone arrays, temperature and humidity sensors and air quality sensors that detect VOCs, CO₂, carbon monoxide (CO) and/or dust.

In some implementations, automated or semi-automated techniques, including machine learning, are contemplated in which the building's environmental control, communications and/or security systems intelligently react to changes in the collected data. As an example, occupancy levels of a room in a building may be determined by the low resolution IR detector as described hereinabove, by light sensors, cameras and/or acoustic sensors, and a correlation may be made between a particular change in level of occupancy and a desired change in HVAC function. For example, an increased occupancy level may be correlated with a need to increase airflow and/or lower a thermostat setting. As a further example, data from air quality sensors that detect levels of dust may be correlated with a need to perform building maintenance or introduce or exclude outside air from interior spaces. In one use case scenario for example, dust levels in a room were observed to rise when the occupants were moving about the room, and to decline with the occupants were seated. In such a scenario, a determination may be made that floor coverings need to be serviced (mopped, vacuumed). In another use case scenario, measured interior air-quality may be observed to (i) improve or (ii) degrade when a window is opened. In the case of (i), it may be determined that air circulation ducts or filters of an HVAC system should be serviced. In the case of (ii) it may be determined that exterior air-quality is poor, and that windows of the building should preferentially be maintained in a closed position. In yet a further use case scenario, a correlation may be drawn between the number of occupants in a conference room, and whether doors and/or windows are open or closed, with Co2 levels and/or rate of change of Co2 levels.

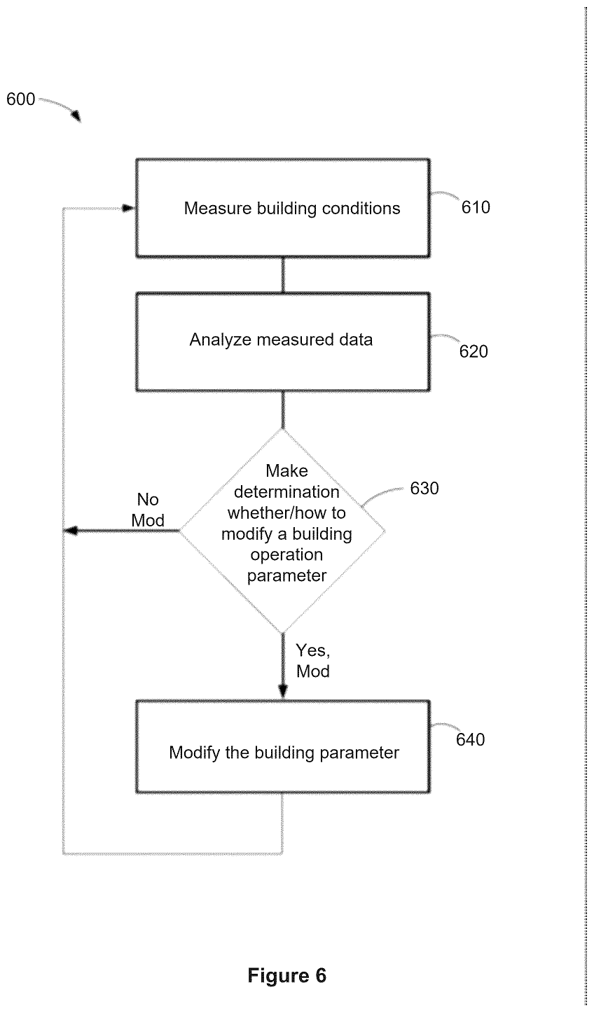

More generally, the present techniques contemplate measuring a plurality of “building conditions,” and controlling “building operation parameters” of a plurality of “building systems” responsive to the measured building conditions, as illustrated in FIG. 6. As used herein, a “building condition” may refer to a physical, measurable condition in a building or a portion of a building. Examples include temperature, air flow rate, light flux and color, occupancy, air quality and composition (particulate count, gas concentration of carbon dioxide, carbon monoxide, water (i.e., humidity)). As used herein, a “building system” may refer to a system that can control or adjust a building operation parameter. Examples include an HVAC system, a lighting system, a security system, a window optical condition control system. A building operation parameter may refer to a parameter that can be controlled by one or more building systems to adjust or control a building condition. Examples include heat flux from or to heaters or air conditioners, heat flux from windows or lighting in a room, air flow through a room, and light flux from artificial lights or natural light through an optically switchable window.

Referring still to FIG. 6, a method 600 may include collecting inputs, block 610, from a plurality of sensors. Some or all of the sensors may be disposed on or associated with a respective window and/or with a respective digital architectural element associated with a window and/or with a digital wall interface. The sensors may include visible and/or IR light sensors or cameras, acoustic sensors, temperature and humidity sensors and air quality sensors, for example. It will be appreciated that the collected inputs may represent a variety of environmental condition measurements that are temporally and spatially diverse. In some implementations, at least some of the inputs may include a combination of sensors. For example separate sensors, specialized for respective measurements of CO₂, CO, dust and/or smoke may be contemplated, and a combination of inputs from the separate sensors may be analyzed (block 620) for determination of air-quality control. As a further example, inputs relevant to a determination of occupancy levels in a room collected from separate sensors that measure, respectively, optical and acoustic signals may be analyzed (block 620). As a yet further example, inputs may be received, nearly simultaneously, from spatially distributed sensors. For example, the sensors may be spatially distributed with respect to a given room or distributed between multiple rooms and/or floors of the building.

In some implementations, analysis of the measured data at block 620 may take into account certain “context information” not necessarily obtained from the sensors. Context information, as used herein may include time of day and time of year, and local weather and/or climatic information, as well as information regarding the building layout, and usage parameters of various portions of the building. The context information may be initially input by a user (e.g. a building manager) and updated from time to time, manually and/or automatically. Examples of usage parameters may include a building's operating schedule, and an identification of expected and/or permitted/authorized usages of individual rooms or larger portions (e.g., floors) of the building. For example, certain portions of the billing may be identified as lobby space, restaurant/cafeteria space, conference rooms, open plan areas, private office spaces, etc. The context information may be utilized in making a determination as to whether or how to modify building operation parameter, block 630, and also for calibration and, optionally, adjustment of the sensors. For example, based on the context information, certain sensors may, optionally, be disabled in certain portions of the building in order to meet an occupant's privacy expectations. As a further example, sensors for rooms in which a considerable number of persons may be expected to congregate (e.g., an auditorium) may advantageously be calibrated or adjusted differently than sensors for rooms expected to have fewer occupants (e.g., private offices).

An objective of the analysis at block 620 may be to determine that a particular building condition exists or may be predicted to exist. As a simple example, the analysis may include comparing a sensor reading such as a light flux or temperature measurement with a threshold. As a further, more sophisticated example, when an occupancy load in a room undergoes a change (because, for example, a meeting in a conference room convenes or adjourns) the analysis at block 620 may, first, directly recognize the change as a result of inputs from acoustic and/or optical sensors associated with the room; second, the analysis may predict an environmental parameter that may be expected to change as a result of a change in occupancy load. For example, an increase in occupancy load can be expected to lead to increased ambient temperatures and increased levels of CO₂. Advantageously, the analysis at block 620 may be performed automatically on a periodic or continuous basis, using models or other algorithms that may be improved over time using, for example, machine learning techniques. In some implementations, the analysis may not explicitly identify a particular building condition (or combination of conditions) in order to determine that a building operation parameter should be adjusted.

Referring again to block 630 a determination as to whether or how to modify building operation parameter may be made based on the results of analysis block 620. Depending on the determination, the building condition may or may not be changed. When a determination is made to not modify building operation parameter the method may return to block 610. When a determination is made to modify a billing for operation parameter, one or more building conditions may be adjusted, at block 640, for purposes of improving occupant comfort or safety and/or to reduce operating costs and energy consumption, for example. For example, lights and/or HVAC service, may be set to a low power condition in rooms that are determined to be unoccupied. As a further example, a determination may be made that a fault or issue has arisen that requires attention of the building's administration, maintenance or security personnel.

The determination may be made on a reactive and/or proactive basis. For example, the determination may react to changes in measured parameters, e.g., a determination may be made to increase HVAC flowrates when a rise in ambient CO₂ is measured. Alternatively or in addition, the determination may be made on a proactive basis, i.e., the building operation parameter may be adjusted in anticipation of an environmental change before the change is actually measured. For example an observed change in occupancy loads may result in a decision to increase HVAC flowrates whether or not a corresponding rise in ambient CO₂ or temperature is measured.

In some implementations, the determination may relate to building operation parameters associated with HVAC (e.g., airflow rates and temperature settings), which may be controlled in one or more locations based on measured temperature, CO₂ levels, humidity, and/or local occupancy. In some implementations the determination may relate to building operation parameters associated with building security. For example, in response to an anomalous sensor reading, a security system alarm may be caused to trigger, selected doors and windows may be locked or unlocked, and/or a tint state of all or some windows may be changed. Examples of security-related building conditions include detection of a broken window, detection of an unauthorized person in a controlled area, and detection of unauthorized movement of equipment, tools, electronic devices or other assets from one location to another.

Other types of security-related building condition information can include information related to detection of the occurrence of the detection of sound outside and/or within the building. In one embodiment, the detected sound is analyzed for type of sound. In some embodiments, analysis is initiated via hardware, firmware, or software onboard to one or more digital structural element or elsewhere in a building, or even offsite. In some embodiments, sound outside or inside of a building causes conductive layers deposited on window glass of an electrochromic window to vibrate, which vibrations cause changes in capacitance between the conductive layers, and which changes of capacitance are converted into a signal indicative of the sound. Thus, some windows of the present invention can inherently provide the functionality of a sound and/or vibration sensor, however, in other embodiments, sound and/or vibration sensor functionality can be provided by sensors that have been added to windows with or without conductive layers, and/or by one or more sensors implemented in digital structural elements.

In one embodiment, an originating location of sound can be determined by analyzing differences in sound amplitude and/or sound time delays that different ones of sound and or vibration sensors experience. Types of sound detected and then analyzed include, but are not limited to broken window sounds, voices (for example, voices of persons authorized or unauthorized to be in certain areas), sounds caused by movement (of persons, machines, air currents), and sounds caused by the discharge of firearms. In one embodiment, depending on the type of sound detected, one or more appropriate security or other action is initiated by one or more system within the building. For example, upon a determination that a firearm has been discharged at a location outside or inside of a building, a building management system makes an automated 911 call to summon emergency responders to the location.

In the case of sound generated by a firearm inside of a building, knowing the precise location (for example, room, floor, and building information) of the sound as well as the shooter who generated the sound is essential to a proper emergency response. However, in buildings with large open space floor plans and/or hallways, textual positional information that requires reference to a particular building's floor plan may delay the response. Rather than just textual positional information, in one embodiment visual positional information is provided. Visual positional information of sound can be provided by installed camera system, if so equipped, but in one embodiment, is provided by causing the tint state of one or more window determined to be the closest to sound generated by the firearm or the shooter to be changed to a distinctive tint state. For example, in one embodiment, upon sensing of a sound of interest, a tint of a tintable window closest to the sound of interest is caused to change to a tint that is darker than the tint of windows that are farther away from the sound, or vice versa. In this manner, if responders were unable to quickly be able to locate a particular room on a particular floor of a particular building, they might to be able to do so by visually looking for a window that has been distinctively tinted to be darker or lighter than other windows.

In one embodiment, a current location of a person associated with a particular sound may be different from their initial location, in which case, their change in location can be updated via detection of other sounds or changes caused by the person to the environment. For example, in the case of an active shooter situation, gas sensors in digital architectural elements or other predetermined locations can be used to monitor changes in air quality caused by the presence of exploded gunpowder, and to thereby provide responders with updates as to location of the shooter. Sound and other sensors could also be used to obtain the location of persons trying to quietly hide from and active shooter (for example, via infrared detection of their location). In one embodiment, to confuse an active shooter, sounds can be generated by speakers in digital architectural elements or other speakers in the shooters location to distract the shooter, or to mask noises made by hostages trying to hide from him. In one embodiment, speakers and/or microphones in digital architectural elements or other devices could be selectively made active to communicate with persons trying to hide from an active shooter. Apart from causing the tint of one or more windows to be made distinctive to help identify the location of sound, in some embodiments, the distinctive tint of the windows may need to be changed to some other tint, for example to provide more light to facilitate entry or egress of one or more persons from a particular location or to provide less light to hinder visibility in a particular location.

Referring still to FIG. 6, at block 640, one or more building parameters may be modified responsive to the determination made at block 630. The building parameter modification may be implemented under the control of a building management system in some embodiments, and may be implemented by one or more of the building's systems such as HVAC, lighting, security, and window controller network, for example. It will be appreciated that the building parameter modification may be selectively made on a global (building-wide) basis or localized areas (e.g. individual rooms, suites of rooms, floors, etc.),

As mentioned, a building system that determines how to modify building operation parameters may employ machine learning. This means that a machine learning model is trained using training data. In certain embodiments, the process begins by training an initial model through supervised or semi-supervised learning. The model may be refined through on-going training/learning afforded by use in the field (e.g., while operating in a functioning building). Examples of training data (building conditions interplay with one another and/or with building operations parameters) include the following combinations of sensed or context data (X or inputs) and building operation parameters or tags (Y or output): (a) [X=occupancy (as measured by IR or camera/video), context, light flux (internal+solar); Y=ΔT/time (without cooling)]; (b) [X=occupancy (as measured by IR or camera/video), context; Y=ΔCO₂/time (with nominal ventilation)]; and (c) [X=occupancy (as measured by IR or camera/video), context, temperature, external relative humidity (RH); Y=ΔRH/time (with nominal ventilation)]. Part of the purpose of machine learning is to identify unknown or hidden patterns or relationships, so the learning typically uses a large number of inputs (X) for each possible output (Y).

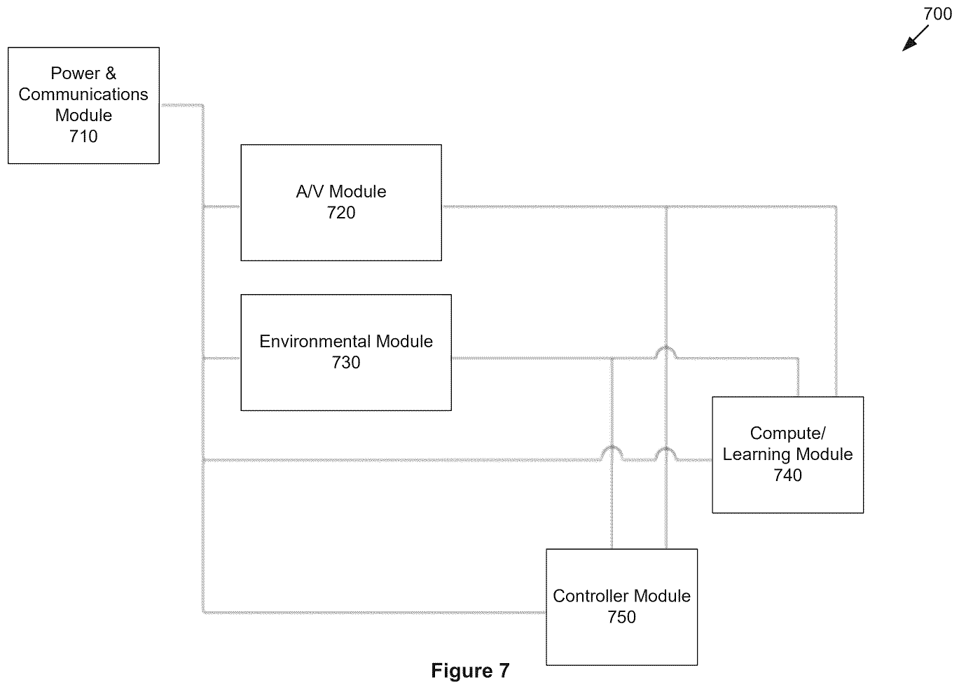

In some embodiments, execution of the process flow illustrated in FIG. 6 may be facilitated by provisioning digital architectural elements with a suite of functional modules for the collection and analysis of environmental data, communications and control. FIG. 7 illustrates an example of a suite of such functional modules, according to an implementation. In the illustrated embodiment, a digital architectural element 700 includes a power and communications module 710, an audiovisual (A/V) module 720, an environmental module 730, a compute/learning module 740 and a controller module 750.

The power and communications module 710 may include one or more wired or wireless interfaces for transmission and reception of communication signals and/or power. Examples of wireless power transmission techniques suitable for use in connection with the presently disclosed techniques are described in U.S. provisional patent application No. 62/642,478, entitled WIRELESSLY POWERED AND POWERING ELECTROCHROMIC WINDOWS, filed Mar. 13, 2018, international patent application PCT/US17/52798, entitled WIRELESSLY POWERED AND POWERING ELECTROCHROMIC WINDOWS, filed Sep. 21, 2017, and U.S. patent application Ser. No. 14/962,975, entitled WIRELESS POWERED ELECTROCHROMIC WINDOWS, filed Dec. 8, 2015, each assigned to the asset any of the present application, the contents of which are hereby incorporated by reference in their entirety into the present application. The power and communications module 710 may be communicatively coupled with and distribute power to each of the audiovisual (A/V) module 720, the environmental module 730, the compute/learning module 740 and the controller module 750. The power and communications module 710 may also be communicatively coupled with one or more other digital architectural elements (not illustrated) and/or interface with a power and/or control distribution node of the building.

The A/V module 730 may include one or more of the A/V components described hereinabove, including a camera or other visual and/or IR light sensor, a visual display, a touch interface, a microphone or microphone array, and a speaker or speaker array. In some embodiments, the “touch” interface may additionally include gesture recognition capabilities operable to detect recognize and respond to non-touching motions of a person's appendage or a handheld object.

The environmental module 730 may include one or more of the environmental sensing components described hereinabove, including temperature and humidity sensors, acoustic light sensors, IR sensors, particle sensors (e.g., for detection of dust, smoke, pollen, etc.), VOC, CO, and/or CO₂ sensors. The environmental module 730 may functionally incorporate a suite of audio and/or electromagnetic sensors that may partially or completely overlap the sensors (e.g., microphones, visual and/or IR light sensors) described above in connection with A/V module 730. In some embodiments, a “sensor” as the term is used herein may include some processing capability, in order, for example, to make determinations such as occupancy (or number of occupants) in a region. Cameras, particularly those detecting IR radiation can be used to directly identify the number of people in a region. Alternatively in addition, a sensor may provide raw (unprocessed) signals to the compute/learning module 740 and/or to the controller module 750.

The compute/learning module 740 may include processing components (including general or special purpose processors and memories) as described hereinabove for the digital architectural element, the digital wall interface, and/or the enhanced functionality window controller. Alternatively or in addition, it may include a specially designed ASIC, digital signal processor, or other type of hardware, including processors designed or optimized to implement models such as machine learning models (e.g., neural networks). Examples include Google's “tensor processing unit” or TPU. Such processors may be designed to efficiently compute activation functions, matrix operations, and/or other mathematical operations required for neural network or other machine learning computation. For some applications, other special purpose processors may be employed such as graphics processing units (GPUs). In some cases, the processors may be provided in a system on a chip architecture.

The controller module 750 may be or include a window control module incorporating one more features described in U.S. patent application Ser. No. 15/882,719, filed Jan. 29, 108, entitled CONTROLLER FOR OPTICALLY-SWITCHABLE WINDOWS, U.S. patent application Ser. No. 13/449,251, filed Apr. 17, 2012, entitled “CONTROLLER FOR OPTICALLY-SWITCHABLE WINDOWS”, International Patent Application No. PCT/US17/47664, filed Aug. 18, 2017, entitled “ELECTROMAGNETIC-SHIELDING ELECTROCHROMIC WINDOWS”, U.S. patent application Ser. No. 15/334,835, filed Oct. 26, 2016, entitled “CONTROLLERS FOR OPTICALLY-SWITCHABLE DEVICES” and International Patent Application No. PCT/US17/61054, filed Nov. 10, 2017, entitled “POWER DISTRIBUTION NETWORKS FOR ELECTROCHROMIC DEVICES”, each assigned to the assignee of the present application and hereby incorporated by reference into the present application in their entireties.

For clarity of illustration, FIG. 7 presents the digital architectural elements 700 as incorporating separate and distinct modules 710, 720, 730, 740 and 750. It should be appreciated however that two or more modules may be structurally combined with each other and/or with features of the digital wall interface described hereinabove. Moreover it is contemplated that, in a building installation including a number of digital architectural elements, not every digital architectural element will necessarily include all the described modules 710, 720, 730, 740 and 750. For example in some embodiments one or more of the described modules 710, 720, 730, 740 and 750 may be shared by a plurality of digital architectural elements.

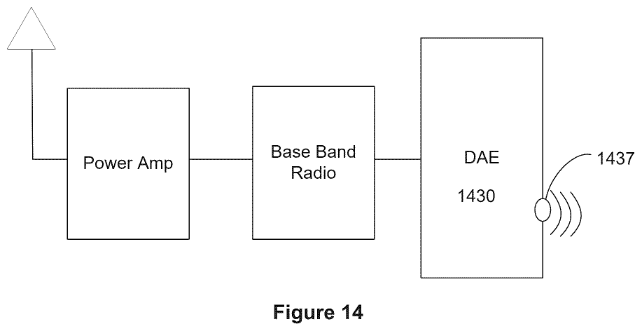

FIGS. 14, 15, and 16 present block diagrams of versions of a digital architectural element, a digital wall interface, or similar device. For convenience, the following discussion will refer to a digital architectural element (DAE). FIG. 14 illustrates a DAE 1430 that can support multiple communication types, including, e.g., Wi-Fi communications with its own antenna 1437. Alternately or in addition the DAE 1430 may include or be coupled with cellular communications infrastructure such as, in the illustrated embodiment, a base band radio, an amplifier, and an antenna. Similarly, while not explicitly shown here, digital architectural element 1530 may support a citizen's band radio system (CBRS) employing a similar base band radio. From a communications and data processing perspective, the digital architectural element in this figure has the same general architecture as the full-featured digital architectural element. But it does not include a sensor and perhaps not ancillary components such as a display, microphone, and speakers.

In some embodiments, digital architectural elements support a modular style sensor configuration that allow for individual upgrade and replacement of sensors via plug and play insertion in a backbone type circuit board having a set of slots or sockets. In one embodiment, sensors used in the digital structural elements can be installed normal to the backbone in one of a multitude of slots/sockets standardized for maximum flexibility and functionality. In some embodiments, the sensors are modular and can be plug and play replaced via removal and insertion through openings in housing of the digital architectural elements. Failed sensors can be replaced or functionality/capabilities can be modified as needed. In one embodiment where digital architectural elements are installed during a construction phase of a project/building, use of plug and play sensors allows customization of digital architectural elements with one or more sensors that may not be needed when the project/building is ready for occupancy. For example, during construction, sensors could be installed to track construction assets within the site or monitor for unsafe (OSHA+) noise or air quality levels and/or a night camera could be installed to monitor movement on a construction site when the site would normally be unoccupied by workers. As desired or needed, after construction, these or other sensors could be removed, and quickly and easily replaced or supplemented during an occupancy phase, or at a later phase, when upgraded or sensors with new capabilities were needed or became available.

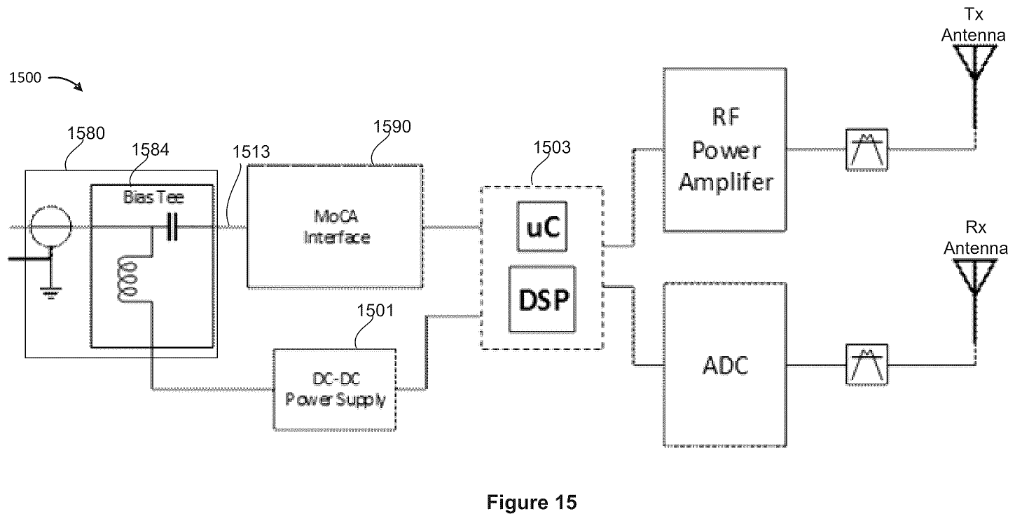

FIG. 15 illustrates a system 1500 of components that may be incorporated in or associated with a DAE. The system 1500 may be configured to receive and transmit data wirelessly (e.g., Wi-Fi communications, cellular communications, citizens band radio system communications, etc.) and to transmit data upstream and receive data downstream via, e.g., a coaxial drop line. In FIG. 15, elements of the system 1500 are presented at a relatively high level. The embodiment illustrated in FIG. 15 includes circuits that serve a similar function to the combination module 1380 (described above in connection with FIG. 13) at the interface of the trunk line and the drop line, specifically, a module 1580 including a bias tec circuit 1584 takes power and data from separate conductors (trunk line) and puts them on one cable (a drop line 1513). Thus, for downstream transmission, a coaxial drop line may deliver both power and data to a MoCA interface 1590 of a digital architectural element on the same conductors.

As illustrated, the system 1500 includes the bias tee circuit 1584 coupled by way of the drop line 1513 to a MoCA interface 1590. The MoCA interface 1590 is configured to convert downstream data signals provided in a MoCA format on coaxial cable (the drop line in this case) to data in a conventional format that can be used for processing. Similarly, the MoCA interface 1590 may be configured to format upstream data for transmission on a coaxial cable (drop line 1513). For example, packetized Ethernet data may be MoCA formatted for upstream transmission on coaxial cable.

In the illustrated example, a DC-DC power supply 1501 receives DC electrical power from the bias tee circuit 1584 and transforms this relatively high voltage power to a lower voltage power suitable for powering the processing components and other components of digital architectural element 1530. In certain implementations, power supply 1501 includes a Buck converter. The power supply may have various outputs, each with a power or voltage level suitable for a component that it powers. For example, one component may require 12 volt power and a different component may require 3.3 volt power.

In some approaches, the bias tee circuit 1584, the MoCA interface 1590, and the power supply 1501 are provided in a module (or other combined unit) that is used across multiple designs of a digital architectural element or similar network device. Such a module may provide data and power to one or more downstream data processing, communications, and/or sensing devices in the digital architectural element. In the depicted embodiment, a processing block 1503 provides processing logic for cellular (e.g., 5G) or other wireless communications functionality as enabled by a transmission (Tx) antenna and associated RF power amplifier and by a reception (Rx) antenna and associated analog-to-digital converter. In certain embodiments, the antennas and associated transceiver logic are configured for wide-band communication (e.g., about 800 MHz-5.8 GHz). Processing block 1503 may be implemented as one or more distinct physical processors. While the block is shown with a separate microcontroller and digital signal processor, the two may be combined in a single physical integrated circuit such as an ASIC.

While the embodiment depicted in FIG. 15 provides separate transmit and receive antennas, other embodiments employ a single antenna for transmission and reception. Further, if a digital architectural element supports multiple wireless communications protocols such as one or more cellular formats (e.g., 5G for Sprint, 5G for T mobile, 4G/LTE for ATT, etc.), it may include separate hardware such antennas, amplifiers, and analog-to-digital converters for each format. Further, if a digital architectural element supports non-cellular wireless communications protocols such as Wi-Fi, citizen's band radio system, etc., it may require separate antennas and/or other hardware for each of these. However, in some embodiments, a single power amplifier may be shared by antennas and/or other hardware for multiple wireless communications formats.

In the depicted embodiment, the processing block 1503 may implement functionality associated with communications such as, for example, a baseband radio for cellular or citizens band radio communications. In some cases, different physical processors are employed for each supported wireless communications protocol. In some cases, a single physical processor is configured to implement multiple baseband radios, which optionally share certain additional hardware such as power amplifiers and/or antennas. In such cases, the different baseband radios may be definable in software or other configurable logic.

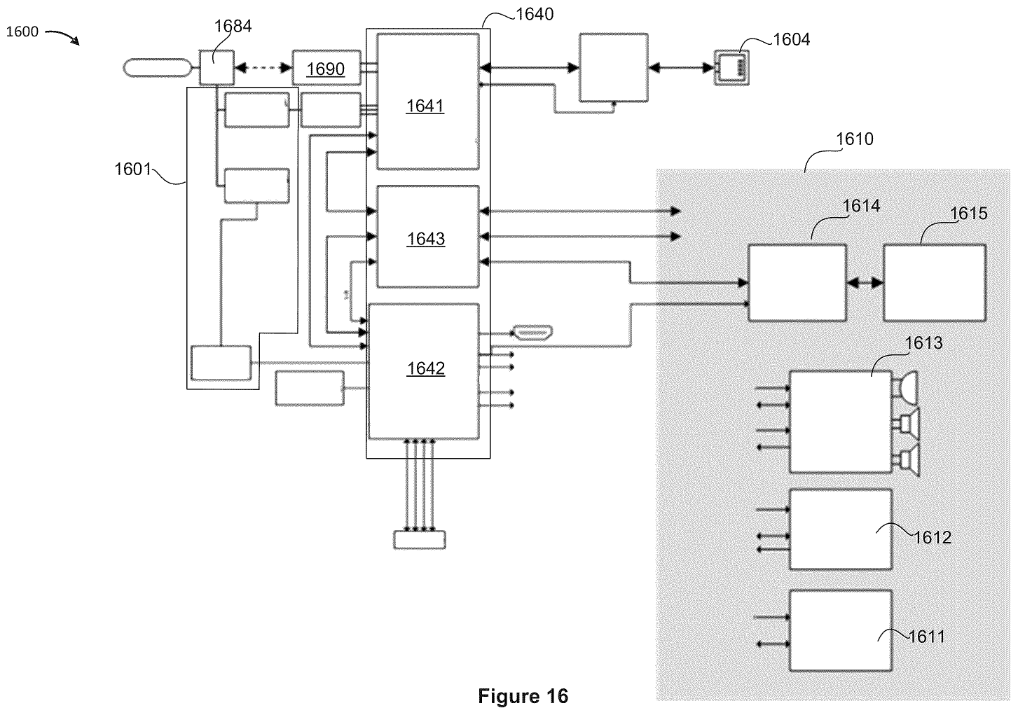

FIG. 16 illustrates an example of a system 1600 of components that may be incorporated in or associated with a digital architectural element. As shown, the system 1600 includes a bias tee circuit 1684 that may work as described above (e.g., similar to bias tee circuit 1584 in FIG. 15). Data from the bias tee circuit 1684 is provided to a MoCA front end module 1690 that works in conjunction with at least a portion of processing block 1640 (for example, a coaxial network controller system on a chip such as the MxL3710, available from MaxLinear, Inc. of Carlsbad, California) to provide high speed data to one or more components of the system 1600.

Power from the bias tec circuit 1584 (e.g., 24 V DC) is provided to one or more voltage regulators in power supply 1601, at least some of which may collectively serve the functions of power supply 1501 in FIG. 15 and provide power to various components of processing block 1640. The processing block 1640 may include, as generally represented at block 1642, a general purpose microprocessor, a microcontroller, a digital signal processor, and integrated circuits of which some or all may contain multiple cores or embedded processors having various processing capabilities. In certain embodiments, processing block 1640 serves the functions of processing block 1503 in FIG. 15. As an example, processing block 1640 may provide CANbus functionality for one or more window controllers.

In the illustrated example, processing block 1640 includes a network switch 1643 which may be, for example a five-port Ethernet switch such as the SJA1105 available from NXP Semiconductors of the Netherlands). MoCA encoded data arriving from the MoCA front end may be decoded to provide data in conventional Ethernet format. That data may then be provided to the network switch, where it may be distributed to various data processing components of the system 1600.

In an embodiment, a modular electrical connector 1604 such as the illustrated RJ45 connector may provide data for any purposes an occupant or building owner might have, e.g., a user laptop or data center connection. In one example, connector 1604 provides a connection for gigabit Ethernet via twisted pair copper wire.

Block 1610 of FIG. 16 includes examples of additional components not illustrated in the embodiment of FIG. 15. In certain embodiments, these are provided together in a single chassis or case or are otherwise provided as a module. In other embodiments, they are provided separately, and each may be integrated in a digital architectural element. As shown, block 1605 includes a sensor module 1611, a video module 1612, an audio module 1613, and window controller elements, including window controller logic 1614 and window controller power circuits 1615. In certain embodiments, some or all of the functionality of window controller 1614 may be implemented in processing block 1640, thereby minimizing or eliminating a requirement for a separate logic element such as window controller logic 1614.

In some embodiments, 5G infrastructure may replace both Wi-Fi and 4G via a single service protocol and associated infrastructure. For example, one or more 5G antennas and associated components in a region of a building may provide wireless communications functionality that serves all needs, effectively replacing the need for Wi-Fi. In certain embodiments, a digital architectural element employs a citizens band radio system (CBRS), which does not require separate license from the FCC or other regulatory body.

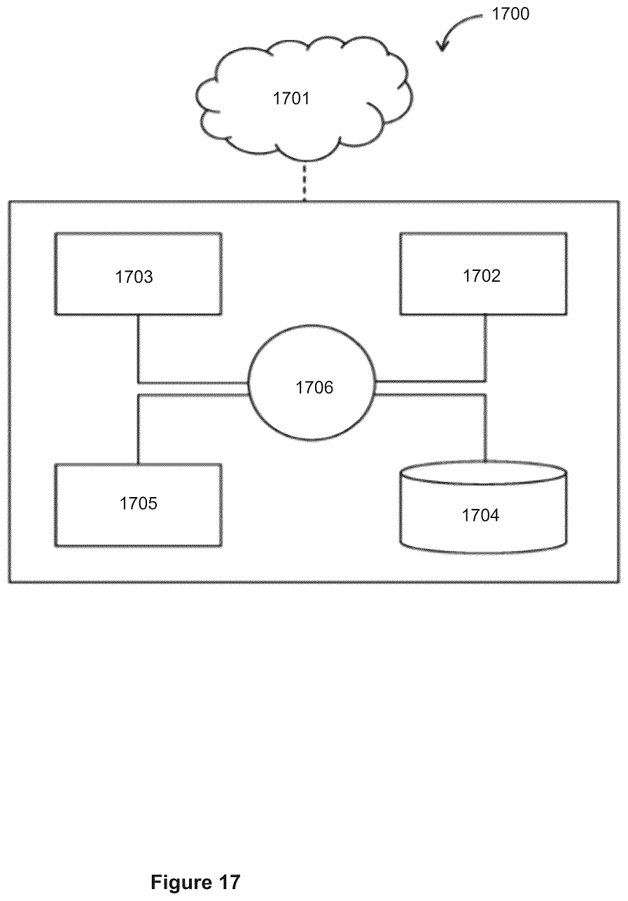

In some embodiments, a computer system may be configured to perform one or more operations of any of the methods provided herein. FIG. 17 shows a schematic example of such a computer system, 1700 The computer system 1700 may include a processing unit 1706 (also referred to herein as a “processor,” “computer” and “computer processor”). The computer system 1700 may include memory or memory location 1702 (e.g., random-access memory, read-only memory, flash memory), electronic storage unit 1704 (e.g., hard disk), communication interface 1703 (e.g., network adapter) for communicating with one or more other systems, and peripheral devices (e.g., 1705), such as cache, other memory, data storage and/or electronic display adapters. In the example shown in FIG. 17, the memory 1702, storage unit 1704, interface 1703, and peripheral devices 1705 are in communication with the processing unit 1706 through a communication bus (solid lines), such as a motherboard. The storage unit can be a data storage unit (or data repository) for storing data. The computer system can be operatively coupled to a computer network (“network”) 1701 with the aid of the communication interface 1703. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 1702. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 1700 can be included in the circuit.

The storage unit can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network. Methods as described herein can be implemented by way of machine (e.g., computer processor) executable code stored on an electronic storage location of the computer system, such as, for example, on the memory 1702 or electronic storage unit 1704. The machine executable or machine-readable code can be provided in the form of software. During use, the processor 1706 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code or can be compiled during runtime. The code can be supplied in a programming language that can be selected to enable the code to execute in a pre-compiled or as-compiled fashion.

In some embodiments, the processor comprises a code. The code can be program instructions. The program instructions may cause the at least one processor (e.g., computer) to direct a feed forward and/or feedback control loop. In some embodiments, the program instructions cause the at least one processor to direct a closed loop and/or open loop control scheme. The control may be based at least in part on one or more sensor readings (e.g., sensor data). One controller may direct a plurality of operations. At least two operations may be directed by different controllers. In some embodiments, a different controller may direct at least two of operations (a), (b) and (c). In some embodiments, different controllers may direct at least two of operations (a), (b) and (c). In some embodiments, a non-transitory computer-readable medium cause each a different computer to direct at least two of operations (a), (b) and (c). In some embodiments, different non-transitory computer-readable mediums cause each a different computer to direct at least two of operations (a), (b) and (c). The controller and/or computer readable media may direct any of the apparatuses or components thereof disclosed herein. The controller and/or computer readable media may direct any operations of the methods disclosed herein.

### CONCLUSION

In the description, numerous specific details were set forth in order to provide a thorough understanding of the presented embodiments. The disclosed embodiments may be practiced without some or all of these specific details. In other instances, well-known process operations were not described in detail to not unnecessarily obscure the disclosed embodiments. While the disclosed embodiments were described in conjunction with the specific embodiments, it will be understood that the specific embodiments are not intended to limit the disclosed embodiments.

1. A system, comprising:
an infrared (IR) detector configured to collect IR imaging data, the IR detector having a field of view;
a controller comprising circuitry configured to process the collected IR imaging data and determine occupancy data for a space, within a building, within the field of view of the IR detector; wherein
the determined occupancy data excludes personally identifiable information (PII) of any occupant in the space.

2. The system of claim 1, wherein the IR detector is configured to collect IR imaging data at a resolution no greater than 100×100 pixels per 1000 square feet of a viewable area within the field of view.

3. The system of claim 2, wherein the resolution is about 32×24 pixels per 1000 square feet of the viewable area.

4. The system of claim 1, further comprising a digital architectural element (DAE) that includes the IR detector and the controller.

5. The system of claim 1, wherein the controller is configured to determine the occupancy data in real time, substantially continuously.

6. The system of claim 1, wherein the controller is a single board computer.

7. A building, comprising:
a plurality of defined spaces; at least some of the defined spaces including:
a respective infrared (IR) detector configured to collect IR imaging data, each IR detector having a respective field of view; and
a respective controller comprising circuitry configured to process the collected IR imaging data and determine occupancy data for a respective defined space; wherein
the determined occupancy data excludes personally identifiable information (PII) of any occupant in the space.

8. The building of claim 7, further comprising a window controller network (WCN) and/or a building management system (BMS), wherein each respective IR detector and controller is included in a respective digital architectural element (DAE) communicatively coupled with the window controller network (WCN) and/or the building management system (BMS).

9. The building of claim 8, wherein a perimeter of at least one of the defined spaces includes a window and the respective DAE is disposed on a mullion or frame of the window.

10. The building of claim 8, wherein a perimeter of at least one of the defined spaces includes a tintable window with a window controller and the respective DAE is communicatively connected to the window controller.

11. The building of claim 8, wherein the window controller network (WCN) and/or the building management system (BMS) are configured to receive the respective determined occupancy data from each DAE.

12. The building of claim 7, wherein the determined occupancy data includes a count of occupants within the space and/or a trajectory of the occupants.

13. The building of claim 7, wherein the collected IR imaging data includes 14. A method comprising:
collecting infrared (IR) imaging data from an IR detector, the IR detector having a field of view;
processing, with a controller comprising circuitry, the collected IR imaging data; and
determining, with the controller, occupancy data for a space, within a building, within the field of view of the IR detector; wherein
the determined occupancy data excludes personally identifiable information (PII) of any occupant in the space.

14. A method comprising:
collecting infrared (IR) imaging data from an IR detector, the IR detector having a field of view;
processing, with a controller comprising circuitry, the collected IR imaging data; and
determining, with the controller, occupancy data fix a space, within a building, within the field of view of the IR detector; wherein
the determined occupancy data excludes personally identifiable information (PII) of any occupant in the space.

15. The method of claim 14, wherein determining the occupancy data comprises:
determining a thermal background signature for the space by periodically capturing IR data when no occupants are present;
subtracting the thermal background signature from collected IR imaging data to construct a difference image; and
using blob detection techniques on the difference image to detect occupants.

16. The method of claim 15, wherein the blob detection techniques include you only look once (YOLO) techniques.

17. The method of claim 14, wherein the IR detector is configured to collect IR imaging data at a resolution no greater than 100×100 pixels per 1000 square feet of a viewable area within the field of view.

18. The method of claim 14, wherein the IR detector and the controller are included in a digital architectural element (DAE).

19. The method of claim 14, wherein the determining occupancy data is performed in real time, substantially continuously.

20. The method of claim 14, wherein the IR detector is an IR thermal sensor array consisting of 768 IR sensors disposed in a 32×24 array.
